(19) United States
(12) Patent Application Publication
(10) Pub. No.: US 2026/0173241 A1
(43) Pub. Date: Jun. 18, 2026

(54) METHOD AND SYSTEM FOR PRODUCING FIELD PERFORMANCES FOR A PLURALITY OF LIGHT-EMITTING DEVICES

(71) Applicant: HYBE Co., Ltd., Seoul (KR)

(72) Inventor: Bo Yoon CHOI, Seoul (KR)

(21) Appl. No.: 19/416,333

(22) Filed: Dec. 11, 2025

(30) Foreign Application Priority Data
Dec. 18, 2024 (KR) 10-2024-0190306
Jan. 8, 2025 (KR) 10-2025-0002547
Jan. 24, 2025 (KR) 10-2025-0011857

(51) Int. Cl. H05B 47/19; G05D 25/02

(52) U.S. Cl. CPC H05B 47/19; G05D 25/02

(57) ABSTRACT

A method for producing a field performance for a plurality of light-emitting devices according to an embodiment of the present disclosure pertains to a method for performing a performance production by controlling a plurality of light-emitting devices by at least one processor of a central control terminal, and includes: acquiring a first control signal including at least one data set in which light emission pattern information is specified for each piece of transmitter identification information; generating at least one piece of light emission state information by combining light emission pattern components included in the light emission pattern information; transmitting the first control signal including the generated light emission state information to the plurality of light-emitting devices using a first communication method; and controlling the plurality of light-emitting devices, which receive a second control signal transmitted from at least one transmitter based on a second communication method, to emit light according to the transmitted light emission state information.

### CROSS-REFERENCE TO RELATED APPLICATION

This application claims the priority to Korean Patent Applications No. 10-2024-0190306, filed on Dec. 18, 2024, No. 10-2025-0002547, filed on Jan. 8, 2025, and No. 10-2025-0011857, filed on Jan. 24, 2025, the entire disclosure of which are hereby incorporated herein by reference in their entirety.

### BACKGROUND

### Field

The present disclosure relates to a method and system for producing a field performance for a plurality of light-emitting devices that generate light emission state information based on different communication methods and control all light-emitting devices in a performance hall regardless of whether each light-emitting device is paired.

### Description of Related Art

Recently, audience members at organized events such as performances, concerts, events, and sporting events have used light-emitting devices in the stands for various reasons, including cheering, aesthetic effects, and the ambiance of the event.

In particular, controlling the display of various colors or effects using light-emitting devices carried by a large number of audience members is utilized as one form of performance production to display a predetermined text or create a specific shape toward an artist.

According to the related art, in order to perform a performance production using a light-emitting device, a library with a light emission pattern preset to match the signature color or song rhythm of a team or artist can be downloaded in advance and applied to the light-emitting device.

However, when an audience member did not download the library in advance due to lack of time or a lack of familiarity with a manipulation method, the audience member had to endure the inconveniences of having to manually manipulate a cheering light stick without being able to participate in the overall controlled performance production.

In addition, in order for an audience member to download the library in advance, the audience member has to separately download a pairing application and essentially perform a pre-pairing process. The more performances the audience member wants to watch, the longer time is required for pairing, which is cumbersome and inconvenient.

In addition, when each audience member watches several performances several times and downloads a plurality of libraries, the data capacity for the library stored in a cheering light stick becomes excessive, thus increasing the probability of errors occurring.

In addition, when dynamic production is performed using all seats in a performance hall as a canvas, it is difficult to deliver diverse pieces of light emission information only with the central control signal due to data capacity issues. In addition, because the dynamic production targets all light-emitting devices, local production is impossible. When there are light-emitting devices that do not perform the library, the uniformity of the performance production may be reduced, which may lower the performance satisfaction of audience members.

In addition, there was still a limitation in that performing a production using only pre-manufactured production data did not allow for adding a new production in real time, making it impossible to perform a production utilizing a cheering light stick for events being performed at a field or for impromptu requests from artists.

Accordingly, discussions are ongoing to ensure that upon holding cheering light sticks, audience members may receive and operate various types of control signals in real time without having to download a library in advance and participate in an immediate performance production.

### RELATED ART DOCUMENTS

### Patent Documents

(Patent Document 1) US 2015-0179029 A1
(Patent Document 2) KR 1936822 B1

### SUMMARY

The present disclosure has been devised to obviate the above limitations of the related art. An aspect of the present disclosure is directed to providing a method and system for producing a field performance for a plurality of light-emitting devices that generate a new type of light emission state information by combining control methods using different types of signals.

In addition, an aspect of the present disclosure is directed to providing a method and system for producing a field performance for a plurality of light-emitting devices that control the light-emitting devices included in the overlapping range of at least one signal.

In addition, an aspect of the present disclosure is directed to providing a method and system for performing a dynamic production based on a plurality of communication methods that generate various types of light emission patterns using only common light emission elements.

In addition, an aspect of the present disclosure is directed to providing a method and system for performing a dynamic production based on a plurality of communication methods that support more natural area transitions in a large-scale production utilizing all of a plurality of areas within a performance hall classified by area.

In addition, an aspect of the present disclosure is directed to providing a method and system for producing a real-time performance based on a drawing interface that immediately generates production data using only sketches input on a canvas based on a seating chart.

In addition, an aspect of the present disclosure is directed to providing a method and system for producing a real-time performance based on a drawing interface that sets a plurality of transmitters to respond in real time to dragging performed when inputting a production sketch.

However, technical aspects to be achieved by the present disclosure and embodiments according to the present disclosure are not limited to the technical aspects described above, and other technical aspects may also exist.

A method for producing a field performance for a plurality of light-emitting devices according to an embodiment of the present disclosure pertains to a method for performing a performance production by controlling a plurality of light-emitting devices by at least one processor of a central control terminal, and includes: acquiring a first control signal including at least one data set in which light emission pattern information is specified for each piece of transmitter identification information; generating at least one piece of light emission state information by combining light emission pattern components included in the light emission pattern information; transmitting the first control signal including the generated light emission state information to the plurality of light-emitting devices using a first communication method; and controlling the plurality of light-emitting devices, which receive a second control signal transmitted from at least one transmitter based on a second communication method, to emit light according to the transmitted light emission state information.

In addition, the acquisition of the first control signal pertains to acquiring the first control signal including the at least one data set in which the transmitter identification information including a transmitter number that specifies a first transmitter among transmitter numbers pre-stored for each transmitter and the light emission pattern information that determines a light emission format of the light-emitting device located within a signal range of the first transmitter are one-to-one matched.

In addition, the generation of the light emission state information includes: setting at least two data sets as integrated data according to a combination corresponding to the number of cases that can be calculated with the transmitter identification information; extracting, for each data set, a light emission pattern component value of the same category among the light emission pattern information included in the at least two data sets of the set integrated data; calculating a median value of the extracted light emission pattern component value; and inserting the extracted median value into a light emission pattern component of the same category to generate the light emission state information.

In addition, the controlling of the plurality of light-emitting devices to emit light according to the transmitted light emission state information includes: controlling to preferentially emit light by transitioning to the light emission state information based on a transmitter number included in the received second control signal when the light-emitting device, which used to emit light according to the first control signal of the first communication method, receives the second control signal of the second communication method.

In addition, the second communication method of the second control signal transmitted by the transmitter is a short-range communication method having a smaller signal range than the first communication method of the first control signal transmitted by the central control terminal, and is a directional electromagnetic signal.

A method for performing a dynamic production based on a plurality of communication methods according to an embodiment of the present disclosure pertains to a method for performing a dynamic production based on a plurality of communication methods by at least one processor of a central control terminal, and includes: generating production data based on a performance production interface; extracting a base source based on the generated production data; determining first dynamic production information to be performed by a first transmitter that emits a projection signal to a first zone based on the extracted base source; generating second dynamic production information to be performed by a second transmitter that emits a projection signal to a second zone adjacent to the first zone; and controlling at least one transmitter existing in a performance hall according to a dynamic path including the first dynamic production information and the second dynamic production information.

In addition, the extraction of the base source includes: extracting at least one commonly used light emission pattern component among a plurality of production styles included in the production data; and determining at least one setting value included in the extracted light emission pattern component as the base source.

In addition, the determination of the first dynamic production information includes: determining at least one of a basic setting value, a minimum setting value, or a maximum setting value for a first dynamic production sequence of the first transmitter; determining at least one of a basic setting value, a minimum setting value, or a maximum setting value for a second dynamic production sequence of the first transmitter; mapping at least one setting value configuring the determined second dynamic production sequence to at least one setting value configuring the determined first dynamic production sequence; and generating the first dynamic production information for controlling the first transmitter according to the setting value mapped between the dynamic production sequences for a predetermined period of time.

In addition, the generation of the second dynamic production information includes: detecting an end setting value of the first dynamic production sequence mapped to an end point in time of the first dynamic production information; and determining the detected setting value as a start setting value of the first dynamic production sequence mapped to a start point in time of the second dynamic production information.

In addition, the method for performing the dynamic production based on the plurality of communication methods according to an embodiment of the present disclosure further includes: transmitting a central signal for driving at least one piece of production data pre-stored in a plurality of light-emitting devices; controlling the plurality of light-emitting devices to emit light by at least one of the central signal or the projection signal; and classifying and controlling a first light-emitting device located in a first projecting shape transmitted by a first projector, a second light-emitting device located in a second projecting shape transmitted by an n-th projector other than the first projector, and a third light-emitting device located in a third projecting shape other than the first projecting shape and the second projecting shape.

A method for producing a real-time performance based on a drawing interface according to an embodiment of the present disclosure pertains to a method for performing a real-time performance production based on a drawing interface by at least one processor of a central control terminal, and includes: uploading a seating chart with at least one pixelated seat to the drawing interface; identifying pixels corresponding to a production sketch input to the drawing interface overlapping the uploaded seating chart; generating light emission pattern information according to pixel information of the identified pixels; and controlling at least one of the central control terminal or a transmitter in real time so that light-emitting devices matching the extracted pixel information emit light with the generated light emission pattern information.

In addition, the uploading of the seating chart includes: pixelating at least one seat included in a first seating chart so that one seat one-to-one corresponds to one pixel; determining coordinates for all the pixelated seats based on coordinate axes of a canvas included in the drawing interface; and matching the pixel information to all the pixelated seats.

In addition, the identification of the pixels corresponding to the production sketch includes: performing preprocessing to add and delete the production sketch included in a first pixel according to a proportion of the production sketch occupied by the first pixel; and determining the preprocessed first pixel as at least one of a production target pixel or a production non-target pixel.

Furthermore, the identification of the pixels corresponding to the production sketch includes: extracting coordinates of the production target pixel for each of at least one shape configuring the production sketch; storing the coordinates of a first shape input initially; removing coordinates that overlap with the coordinates extracted from the first shape among the coordinates extracted from the at least one shape input after the first shape; and extracting pixel information of production target pixels filtered by removing the overlapping coordinates.

In addition, the controlling of the central control terminal in real time to emit light with the generated light emission pattern information includes: updating a first central signal by adding first pixel information and first light emission pattern information to the first central signal; transmitting the updated first central signal; and controlling the central control terminal so that only light-emitting devices that have pre-stored the first pixel information included in the updated first central signal emit light according to the first light emission pattern information.

In addition, the controlling of the transmitter in real time to emit light with the generated light emission pattern information includes: extracting at least one transmitter that transmits a projection signal to the first pixel information; determining a frame of the extracted transmitter as a shape of the production sketch; and controlling the transmitter so that the at least one transmitter transmits a projection signal including the first light emission pattern information according to the determined frame.

In addition, the controlling of the transmitter in real time further includes: sensing a drag event occurring in the production sketch; calculating a drag path of the sensed drag event; generating a dynamic path command for a plurality of transmitters according to the calculated drag path; and controlling a movement speed of the at least one transmitter according to the generated dynamic path command.

In addition, a system for producing a field performance for a plurality of light-emitting devices according to an embodiment of the present disclosure is interlocked with the plurality of light-emitting devices, and includes a central control terminal including at least one memory and at least one processor, wherein at least one application stored in the memory and executed by the processor operates in accordance with instructions for: acquiring a first control signal including at least one data set in which light emission pattern information is specified for each piece of transmitter identification information; generating at least one piece of light emission state information by combining light emission pattern components included in the light emission pattern information; transmitting the first control signal including the generated light emission state information to the plurality of light-emitting devices using a first communication method; and controlling the plurality of light-emitting devices, which receive a second control signal transmitted from at least one transmitter based on a second communication method, to emit light according to the transmitted light emission state information.

In addition, a system for performing a dynamic production based on a plurality of communication methods according to an embodiment of the present disclosure is interlocked with: a plurality of light-emitting devices; and a plurality of transmitters, and includes a central control terminal including at least one memory and at least one processor, wherein at least one application stored in the memory and executed by the processor operates in accordance with instructions for: generating production data based on a performance production interface; extracting a base source based on the generated production data; determining first dynamic production information to be performed by a first transmitter that emits a projection signal to a first zone based on the extracted base source; generating second dynamic production information to be performed by a second transmitter that emits a projection signal to a second zone adjacent to the first zone; and controlling at least one transmitter existing in a performance hall according to a dynamic path including the first dynamic production information and the second dynamic production information.

In addition, a system for producing a real-time performance based on a drawing interface according to an embodiment of the present disclosure is interlocked with: a plurality of light-emitting devices; and a plurality of transmitters, and includes a central control terminal including at least one memory and at least one processor, wherein at least one application stored in the memory and executed by the processor operates in accordance with instructions for: uploading a seating chart with at least one pixelated seat to the drawing interface; acquiring a production sketch input to the drawing interface overlapping the uploaded seating chart; preprocessing the production sketch based on coordinates of the acquired production sketch; extracting pixel information corresponding to the preprocessed production sketch; generating light emission pattern information based on the input production sketch; and controlling the light-emitting devices matching the extracted pixel information to emit light with the generated light emission pattern information.

The method and system for producing the field performance for the plurality of light-emitting devices according to an embodiment of the present disclosure combine control methods using different types of signals to generate a new type of light emission state information. This overcomes the limitations of a limited communication range, thereby enabling more diverse performance productions and enhancing the quality of an event.

In addition, the method and system for producing the field performance for the plurality of light-emitting devices according to an embodiment of the present disclosure control the light-emitting devices included in a range where at least one signal overlaps. This ensures that the light-emitting devices located in the overlapping range are consistent with the overall production concept, thereby enhancing the unity of a performance production.

In addition, the method and system for producing the field performance for the plurality of light-emitting devices according to an embodiment of the present disclosure generate various types of light emission patterns using only common light emission elements, thereby increasing data economy, dramatically reducing error rates due to data overload, and enabling more efficient performance productions.

In addition, the method and system for producing the field performance for the plurality of light-emitting devices according to an embodiment of the present disclosure create the feeling of using the entire audience seats as a canvas going beyond localized productions, thereby fostering a sense of connection among audience members and eliminating any potential sense of difference in the production among areas.

In addition, the method and system for producing the field performance for the plurality of light-emitting devices according to an embodiment of the present disclosure generate production data immediately using only sketches input to a canvas based on a seating chart. This facilitates the generation of production data with ease and speeds up the actual implementation, thereby increasing the adaptability of the production data to a field.

In addition, the method and system for producing the field performance for the plurality of light-emitting devices according to an embodiment of the present disclosure set a plurality of transmitters to respond in real time to dragging performed during the production sketch input, thereby enabling intuitive and dynamic performance production according to the intentions of a producer.

The benefits of the present disclosure are not limited to those mentioned above, and other benefits not mentioned may be clearly understood by those skilled in the art from the following description.

### BRIEF DESCRIPTION OF THE DRAWING

FIG. 1 is a conceptual diagram illustrating a system for producing a performance using light emission state information according to an embodiment of the present disclosure.

FIG. 2 is an internal block diagram illustrating a central control terminal according to an embodiment of the present disclosure.

FIG. 3 is an internal block diagram illustrating a transmitter according to an embodiment of the present disclosure.

FIG. 4 is an internal block diagram illustrating a light-emitting device according to an embodiment of the present disclosure.

FIG. 5 is a flowchart illustrating a method for producing a field performance for a plurality of light-emitting devices according to an embodiment of the present disclosure.

FIG. 6 is a diagram illustrating a central signal and a projection signal according to an embodiment of the present disclosure.

FIG. 7 is a diagram illustrating an overlapping range for receiving a plurality of projection signals according to an embodiment of the present disclosure.

FIG. 8 is a diagram illustrating light emission state information generated by acquiring a plurality of projection signals according to an embodiment of the present disclosure.

FIG. 9 is a flowchart illustrating a method for performing a dynamic production based on a plurality of communication methods according to an embodiment of the present disclosure.

FIG. 10 is an example of production data according to an embodiment of the present disclosure.

FIG. 11 is an example of a diagram illustrating a base source according to an embodiment of the present disclosure.

FIG. 12 is an example of a diagram illustrating dynamic production information according to an embodiment of the present disclosure.

FIG. 13 is a flowchart illustrating a method for generating second dynamic production information based on first dynamic production information according to an embodiment of the present disclosure.

FIG. 14 is an example of implementing a chain effect based on the first dynamic production information and the second dynamic production information according to an embodiment of the present disclosure.

FIG. 15 is a flowchart illustrating a method for producing a real-time performance production based on a drawing interface according to an embodiment of the present disclosure.

FIG. 16 is an example of determining coordinates for a seating chart uploaded to a drawing interface according to an embodiment of the present disclosure.

FIG. 17 is an example of a drawing sketch input to a drawing interface according to an embodiment of the present disclosure.

FIG. 18 is an example of a diagram illustrating preprocessing of a production sketch according to an embodiment of the present disclosure.

FIG. 19 is an example of extracting pixel information corresponding to a production sketch according to an embodiment of the present disclosure.

### DETAILED DESCRIPTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure, including the drawings, to refer to the same or like parts. As such, the repeatable description of the same or like parts will be omitted.

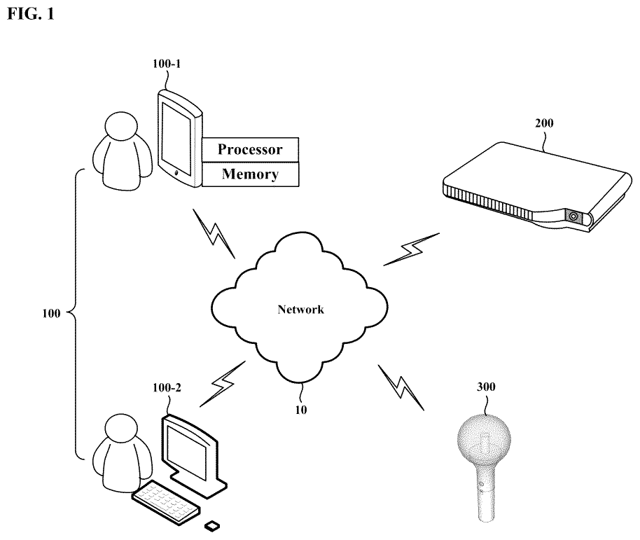

FIG. 1 is a conceptual diagram illustrating a system for producing a performance using light emission state information according to an embodiment of the present disclosure.

Referring to FIG. 1, the system for producing the performance using the light emission state information according to an embodiment of the present disclosure (hereinafter, “performance production system”) may provide a performance production service that controls a plurality of cheering light sticks by generating the light emission state information of a new structure based on different communication methods (hereinafter, “performance production service”).

In an embodiment, the performance production service refers to a service that performs a performance production by acquiring a central signal transferred using a first communication method and a projection signal transferred using a second communication method to generate light emission state information, and projecting the generated light emission state information onto a plurality of light-emitting devices.

In an embodiment, the performance production system as described above may be connected through a central control terminal 100, a transmitter 200, a light-emitting device 300, and a network 10.

Herein, the network 10 according to an embodiment refers to a connection structure capable of exchanging information between nodes such as the central control terminal 100, the transmitter 200 and/or the light-emitting device 300. Examples of the network 10 include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the central control terminal 100, the transmitter 200, and the light-emitting device 300 implementing a service providing system will be described in detail with reference to the attached drawings.

### Central Control Terminal 100

The central control terminal 100, according to an embodiment of the present disclosure, may be a predetermined computing device having a central control application (hereinafter, an “application”) installed that provides the performance production service.

Specifically, from a hardware point of view, the central control terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the performance production service based on wired/wireless communication, such as a fixed-type desktop PC, a laptop computer, and a personal computer, such as an ultrabook, in which the application is installed.

In addition, according to an embodiment, the central control terminal 100 may further be implemented by, or linked to, a predetermined server computing device that provides a performance production service environment.

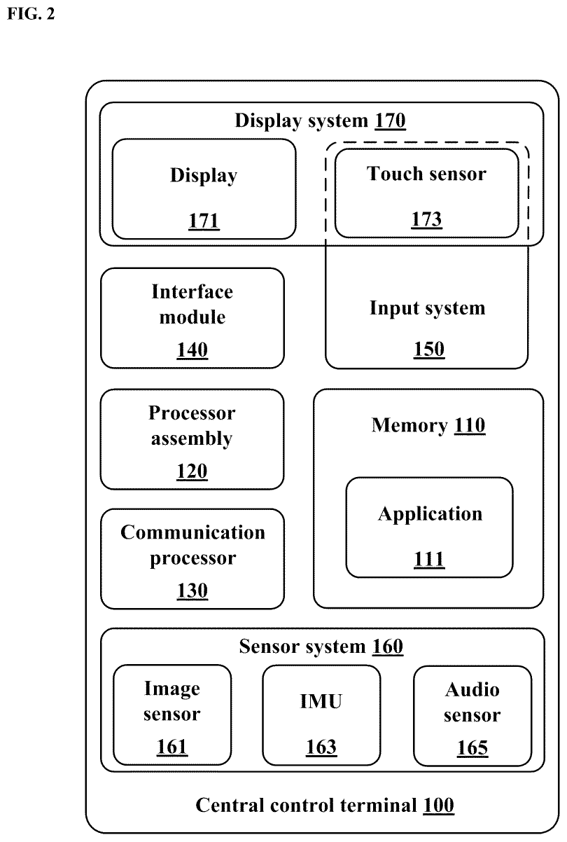

FIG. 2 is an internal block diagram illustrating a central control terminal according to an embodiment of the present disclosure.

Referring to FIG. 2, from a functional point of view, the central control terminal 100 may include a memory 110, a processor assembly 120, a communication processor 130, an interface module 140, an input system 150, a sensor system 160, and a display system 170. These components may be configured to be included within a housing of the central control terminal 100.

Specifically, the memory 110 may store an application 111, and the application 111 may store one or more of various application programs, data, and instructions for providing the performance production service environment.

In other words, the memory 110 may store commands and data used for generating the performance production service environment.

In addition, the memory 110 may include a program area and a data area.

Herein, the program area according to an embodiment may be linked between an operating system (OS) for booting the central control terminal 100 and functional elements, and the data area may store data generated according to the use of the central control terminal 100.

In addition, the memory 110 may include at least one non-transitory computer-readable storage medium and a temporary computer-readable storage medium.

For example, the memory 110 may be implemented by various storage devices, such as a ROM, an EPROM, a flash drive, and a hard drive; and may further include web storage performing a storage function of the memory 110 on the Internet.

The processor assembly 120 may include at least one processor capable of executing commands of the application 111 stored in the memory 110 to perform various tasks for generating the performance production service environment.

In an embodiment, the processor assembly 120 may control the overall operation of components through the application 111 of the memory 110 in order to provide the performance production service.

The processor assembly 120 may be a system-on-chip (SOC) suitable for the central control terminal 100 that includes a central processing unit (CPU) and/or graphics processing unit (GPU), may execute the OS and/or an application program stored in the memory 110, and control each component mounted on the central control terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with another central control terminal 100 or an external server storing a content source for implementing the performance production service environment, and may communicate with various user input components such as a controller receiving a user input.

In an embodiment, the communication processor 130 may transmit/receive various pieces of data related to the performance production service to/from another central control terminal 100 and/or an external server.

This communication processor 130 may wirelessly transmit and receive data with at least one of a base station, an external terminal, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The interface module 140 may communicatively connect the central control terminal 100 with one or more other devices. Specifically, the interface module 140 may include wired and/or wireless communication devices that are compatible with one or more different communication protocols.

The central control terminal 100 may be connected to various input/output devices through the interface module 140.

For example, the interface module 140 may be connected to an audio output device such as a headset port or a speaker to output audio.

Although it has been described as an example that the audio output device is connected through the interface module 140, an embodiment in which the audio output device is installed in the central control terminal 100 may also be included.

In addition, for example, the interface module 140 may be connected to an input device such as a keyboard and/or mouse to acquire a user input.

This interface module 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, gestures, voice commands, touch input, mouse input, keyboard input, gesture input, motion input using guide tools, operation of a button, or other types of input) related to the performance production service.

Specifically, the input system 150 may receive a user motion input via a predetermined button, a touch sensor, and/or an image sensor 161 of the sensor system 160.

In addition, the input system 150 may be connected to an external controller through the interface module 140 to receive a user input.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the central control terminal 100.

In an embodiment, the image sensor 161 may capture and acquire various images and/or videos related to the performance production service.

In addition, the image sensor 161 may be disposed on the front or/and rear side of the central control terminal 100 to acquire an image by capturing the disposed direction side, and may capture a physical space through a camera disposed toward the outside of the central control terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image acquired through the image sensor device using an image recognition process (for example, OCR) and/or an image processing module to extract necessary information, and deliver the extracted information to a processor.

The image sensor 161 may be a camera assembly including at least one camera. The camera assembly may include a general camera that captures a visible light band, and may further include a special camera such as an infrared camera, a stereo camera, and/or an AI camera.

According to an embodiment, one camera assembly may be configured as a combination of at least one general camera and special cameras, or may be configured as a system in which a plurality of general cameras and special cameras individually transfer sensed image data to a processor through an interface module.

In addition, the image sensor 161 as described above may be included in the central control terminal 100 and operated according to an embodiment, or may be included in an external device (for example, an external server) and operated through linkage based on the communication processor 130 and/or the interface module 140 described above.

The IMU 163 may sense at least one of motion and acceleration of the central control terminal 100. For example, the IMU 163 may include a combination of various position sensors such as an accelerometer, a gyroscope, and a magnetometer.

In addition, the IMU 163 may interwork with a positioning module, such as a GPS module of the communication processor 130 to recognize spatial information on the physical space around the central control terminal 100.

The audio sensor 165 may recognize a sound around the central control terminal 100.

In detail, the audio sensor 165 may include a microphone capable of sensing voice input of a user using the central control terminal 100.

In an embodiment, the audio sensor 165 may receive speech data necessary for the performance production service from a user.

The display system 170 may output various pieces of information related to the performance production service as a graphic image.

In an embodiment, the display system 170 may display various user interfaces for the performance production service.

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the central control terminal 100, and a user interface may include a touch sensor 173 on a display 171 configured to receive a user touch input.

In detail, the display system 170 may include the display 171 that outputs an image and the touch sensor 173 that senses a user touch input.

For example, the display 171 may form an overlaid structure with the touch sensor 173 or be integrally formed with the touch sensor 173 to implement a touch screen. Such a touch screen may function as a user input unit that provides an input interface between the central control terminal 100 and the user, and may provide an output interface between the central control terminal 100 and the user.

The central control terminal 100, including the aforementioned components, may store at least one transmitter number information, light emission pattern information, a central signal, a projection signal, and/or light emission state information in the memory 110 according to an embodiment.

In an embodiment, the central control terminal 100 may transmit the central signal transferred using the first communication method to at least one other device (in an embodiment, the light-emitting device 300) in a one-to-many manner.

For example, the central control terminal 100 may transmit the control signal to at least one light-emitting device 300 via a broadcasting method (an all-to-all communication method that delivers traffic to an unspecified number of recipients without designating a recipient).

In addition, in detail, the central control terminal 100 may transmit the control signal to the light-emitting devices located nearby using a preset broadcast protocol. The light-emitting devices located nearby and set to receive broadcast signals using the preset broadcast protocol may receive the transmitted control signal, and the light-emitting devices may operate according to the received control signal.

In this connection, the preset broadcast protocol may refer to a frequency band, and a control signal encoding/decoding method. The transceiver included in the communication processor 130 (hereinafter, transceiver 221) may include a broadcast transmitter. In addition, the broadcast transmitter may include an exciter composed of an oscillator and a modulator, modulate the control signal received from the central control terminal 100 into radio waves of a determined frequency band according to the preset broadcast protocol, and transmit an RF signal through an antenna.

In other words, in this specification, the central control terminal 100 is described as a console that generates data (for example, light emission state information) defining the light emission of the light-emitting devices 300 and transfers the generated data to the transmitter 200 and/or the light-emitting device 300 using a predetermined signal (for example, an RF signal).

The data defining the light emission may be generated directly by the central control terminal 100, but it may also be acquired indirectly by pre-generating the data in a producer terminal and transferring the same to the central control terminal 100. In the latter case, the data pre-generated in the producer terminal is transferred in conjunction with the central control terminal 100, allowing the central control terminal 100 to function as the producer terminal and perform overall control of the performance production system.

According to an embodiment, the central control terminal 100 may further perform at least some of the functional operations performed by the transmitter 200 to be described below.

### Transmitter 200

The transmitter 200 according to an embodiment of the present disclosure may be a computing device that emits a predetermined control signal to the light-emitting device 300 under the control of the central control application 111 providing the performance production service.

In detail, the transmitter 200 according to an embodiment may determine a light-emitting range using the light emission pattern information specified by the central control terminal 100 and emit a control signal to the light-emitting devices 300 located within the relevant range, thereby controlling the light-emitting devices 300 to emit light according to the emitted control signal.

More specifically, in an embodiment, the transmitter 200 may operate as an integrated and/or separate unit with a projector that projects a predetermined image onto a predetermined area, thereby transmitting a predetermined control signal.

Herein, the predetermined image may refer to the shape of a beam projected by at least one projector. The shape of the beam projected by the projector may be controlled in the area being irradiated by combining the projected areas of a plurality of projectors or by controlling the shape of the beam projected by the optical module within each projector.

In other words, in an embodiment, the control signal transmitted by the transmitter 200 may be transmitted in various forms depending on the frame mapped to the image.

In addition, the beam projected by the projector may include light of various wavelength bands. Infrared bands or long-wavelength visible light bands that do not interfere with the lighting production within a performance and do not obstruct the view of audience members may be readily available.

In addition, the projector may project a beam including information contained in the control signal by controlling at least one factor of a beam wavelength band, beam output cycle, intensity, brightness (black, white and grayscale) and saturation.

In other words, the transmitter 200 according to an embodiment may perform the function of a projector that transmits a control signal within a predetermined short distance.

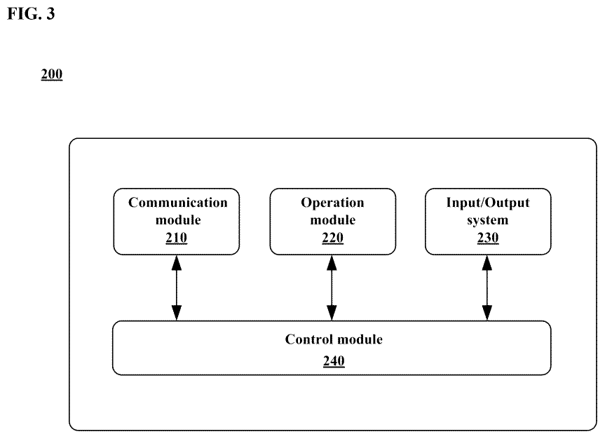

FIG. 3 is an internal block diagram illustrating a transmitter according to an embodiment of the present disclosure.

Referring to FIG. 3, the transmitter 200 according to an embodiment may include a communication module 210, an operation module 220, an input/output system 230, and/or a control module 240.

The communication module 210 may include one or more devices for communicating with the central control terminal 100 and/or the light-emitting device 300.

In an embodiment, the communication module 210 may transmit and receive various pieces of data related to control signal communication with other terminals and/or external servers to implement an environment for control signal communication.

This communication module 210 may wirelessly transmit and receive data with at least one of a base station, an external terminal, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI), short-range communication methods (for example, NFC, RFID) and/or wireless communication method (for example, RF, IR) for mobile communication.

In addition, in an embodiment, the communication module 210 may include a wireless communication module for short-range communication (for example, at least one of an NFC module, an IR transmitter/receiver, an RF transmitter/receiver, a ZigBee module, a Bluetooth module, and a Wi-Fi module).

In this specification, the communication module 210 of the transmitter 200 is described as using a wireless communication method that transmits and receives IR signals.

Specifically, in an embodiment, the communication module 210 may transfer data generated by the central control terminal 100 and/or the transmitter 200 to at least one light-emitting device 300 using a predetermined signal (in an embodiment, an IR signal).

The operation module 220 may operate a predetermined structure included in the transmitter 200 so that the transmitter 200 emits a predetermined control signal.

The operation module 220 may project a directional electromagnetic signal based on a signal-emitting unit. In this connection, in an embodiment, the electromagnetic signal may have a wavelength within the infrared, visible light, and/or ultraviolet spectrum.

Accordingly, in an embodiment, the operation module 220 may project a control signal including the light emission state information to at least one light-emitting device 300 located within a specific range within a predetermined space (for example, within a performance hall).

The input/output system 230 may be connected to an external controller and receive user input.

Accordingly, the input/output system 230 may sense user input related to the performance production service (for example, gestures, voice commands, touch input, mouse input, keyboard input, gesture input, motion input using guide tools, operation of a button, or other types of input).

For example, a user may perform predetermined input to operate a predetermined portion of the operation module 220 of the transmitter 200 based on the input/output system 230.

In addition, the input/output system 230 may display predetermined data downloaded to provide the performance production service based on a predetermined display (for example, an LCD display).

The control module 240 may control the communication module 210 and/or the operation module 220, which are connected wiredly and/or wirelessly, to communicate with each other. In addition, the control module 240 may also be controlled to communicate with other external terminals.

Specifically, the control module 240 may control components within the transmitter 200 to emit control signals in various forms based on images generated by the transmitter 200 and/or images acquired from other devices.

To this end, frames that determine the form, intensity, emission range, and dynamic production of the control signal may be mapped in advance to the generated and/or acquired images.

Herein, the control module 240, according to an embodiment, may set the emission range by adjusting the brightness or intensity (for example, darkening or lightening) of the control signal emitted based on the image (for example, implemented in black, white, and/or grayscale). In another embodiment, the emission range may be set by adjusting the size and form of the control signal.

In other words, the control module 240 may control the transmitter 200 to emit control signals in various forms based on frames mapped to the image.

The transmitter 200 described above may have a predetermined hardware structure for determining the shape of a light-emitting signal.

In an embodiment, the operation module 220 of the transmitter 200 may include the signal-emitting unit and/or a moving head. The components included in the operation module 220 described below may be composed of any optical element that emits a predetermined control signal and changes the intensity, projection range, size, and form of the emitted control signal, and are not limited only to the elements described below.

The signal-emitting unit may be an assembly that emits an electromagnetic signal (for example, a control signal) of a predetermined wavelength.

For example, the signal-emitting unit may emit an image manufactured in black, white, and/or grayscale as an IR signal.

The signal-emitting unit may be located on one side of the moving head and emit a control signal in a direction determined by the angle adjustment of the moving head. In this connection, the moving head may change the angle according to the frame or sequence mapped to the image generated and/or acquired by the transmitter 200.

The moving head may include a predetermined motor for adjusting the angle of the control signal emission range of the signal-emitting unit.

In other words, the moving head may control the direction, angle, and speed when the control signal is emitted from the transmitter 200 using a predetermined motor power. For example, the moving head may be capable of rotating up, down, left, and right. In other words, the control module 240 of the transmitter 200 may adjust the emission form and/or emission range of the control signal emitted from the signal-emitting unit by mapping a frame corresponding to a shape included in the relevant image generated by the transmitter 200 or acquired from another device.

Accordingly, the control module 240 of the transmitter 200 may emit a projection signal implemented in at least one of black, white, and/or grayscale by changing the same to a different type according to the frame mapped to the relevant signal.

Accordingly, the control module 240 of the transmitter 200 may sequentially change the angle of the moving head, the moving speed, and/or the form of the mapped frame, and the form change speed over time to perform a predetermined dynamic production in the field performance production.

### Light-Emitting Device 300

In an embodiment of the present disclosure, the light-emitting device 300 may be a predetermined device that emits light according to a control signal including setting values such as brightness, color, saturation, and effect received from the central control terminal 100 and/or the transmitter 200 based on the performance production service.

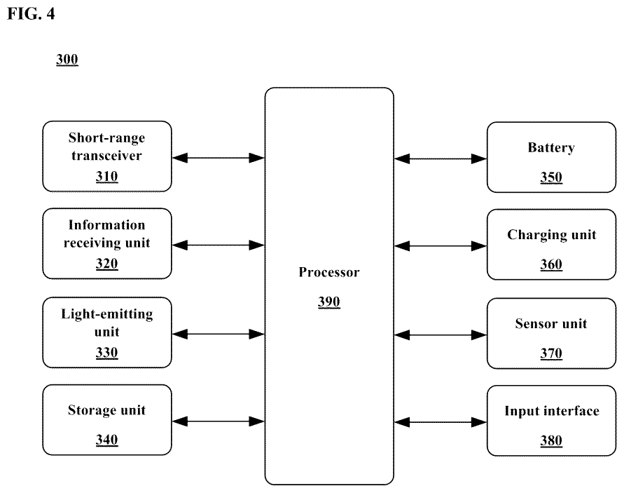

FIG. 4 is an internal block diagram illustrating a light-emitting device according to an embodiment of the present disclosure.

Referring to FIG. 4, in an embodiment, the light-emitting device 300 may include a short-range transceiver 310, an information receiving unit 320, the light-emitting unit 330, a storage unit 340, a battery 350, a charging unit 360, a sensor unit 370, an input interface 380, and a processor 390.

The short-range transceiver 310 may include one or more devices for communicating with an external device. The short-range transceiver 310 may communicate through a wired and/or wireless network.

In an embodiment, the short-range transceiver 310 may transmit and receive various pieces of data related to the performance production service to and from another terminal and/or an external server.

The short-range transceiver 310 may include a wireless communication module (for example, at least one of an infrared communication module, an NFC module, an IR transmitter/receiver, an RF transmitter/receiver, a ZigBee module, a Bluetooth module, and a Wi-Fi module).

The information receiving unit 320 may include a broadcast receiver that receives information transmitted by a broadcasting method from a transmitter 200 and other devices. Specifically, the broadcast receiver may receive radio waves transmitted from the transmitter 200 through an antenna and acquire a control signal by filtering out the control signal from the received radio waves.

In other words, the information receiving unit 320 may receive predetermined information (in an embodiment, information on the number of the transmitter 200, the direction of propagation, and/or the light emission pattern of the light-emitting device 300) included in the central signal and/or the projection signal from the transmitter 200.

In other words, since receiving the information means that the relevant light-emitting device 300 is a light-emitting target, the relevant light-emitting device 300 may emit light according to the received information.

The light-emitting unit 330 may perform a function of emitting light according to the control signal received by the information receiving unit 320.

The light-emitting unit 330 may include one or more light source elements, and the light source may include a light-emitting diode (LED). Also, the light-emitting unit 330 may include LEDs of different colors; for example, the light-emitting unit 330 may include at least one of a red LED, a green LED, a blue LED, or a white LED.

When the light emitted from each of these LEDs is mixed, a wide range of colors may be created, and the mixed color is determined based on the ratio of the intensities of light emitted from each LED, where the intensity of light emitted from each LED may be proportional to the driving current of the LED.

A plurality of LEDs included in the light-emitting unit 330 may be arranged in the form of dots, where a specific word (text), image, or video may be displayed as the plurality of LEDs are selectively turned on or off according to the control of the processor 390 described later.

In the description above, an LED is used as a light source of the light-emitting unit 330, but the type of light source is not limited to the LED. According to another embodiment, an organic light-emitting diode (OLED) may also be used as the light source.

The storage unit 340 may store one or more of various application programs, applications, data, and instructions for providing the performance production service environment.

In addition, the storage unit 340 may store data received from or generated by other components of a performance production system. The storage unit 340 may be, for example, one of various storage devices such as a ROM, an EPROM, a flash drive, a hard drive, and/or a USB drive, and may include a memory, a cache, and a buffer.

In an embodiment, the storage unit 340 may pre-store the information necessary to perform a light emission function of the light-emitting device 300.

In addition, the storage unit 340 may store at least one of a library and/or a scenario that specifies the light emission form in which the light-emitting device 300 operates.

Furthermore, in an embodiment, the storage unit 340 may store information necessary to perform the performance production service.

The battery 350 may receive external and/or internal power under the control of the processor 390 to supply the power required to operate each component of the light-emitting device 300.

The battery 350 may further include a DC/DC converter capable of converting the received power to a voltage level that may be used by the payloads of the light-emitting device 300.

In addition, the battery 350 includes at least one battery cell. Each battery cell is not particularly limited to a specific type as long as the battery cell may be repeatedly charged and discharged, such as a lithium-ion cell.

The charging unit 360 may include a wired and wireless charging module for providing a wired and wireless charging process for supplying the power required for the operation of the light-emitting device 300.

The sensor unit 370 may include at least one of a position sensor (IMU), an acceleration sensor, a gyro sensor, a distance sensor, a proximity sensor, a contact sensor, or an illumination sensing sensor.

Specifically, the position sensor (IMU) included in the sensor unit 370 may sense at least one of the motion or acceleration of the light-emitting device 300. For example, the position sensor may be implemented as a combination of various position sensors such as an accelerometer, a gyroscope, and a magnetometer.

The input interface 380 may sense the input (for example, a gesture, actuation of a button, or other types of inputs) of a user (for example, an audience member using the light-emitting device 300) related to the performance production service.

Specifically, the input interface 380 may include a predetermined button and/or a touch sensor.

In addition, the input interface 380 may be connected to an external controller to receive the input of the user.

The processor 390 may perform the overall operation such as power supply control of the light-emitting device 300 and a data processing function of controlling a signal flow between internal configurations of the light-emitting device 300 and processing data. The processor 390 may include at least one processor.

In addition, the processor 390 may communicate with each component internally through a system bus and may include one or more predetermined bus structures including a local bus.

In addition, the processor 390 may be implemented by using at least one of the ASICs, DSPs, DSPDs, PLDs, FPGAs, controllers, micro-controllers, microprocessors, or electric units for performing other functions.

In an embodiment, the processor 390 may control the light emission pattern of the light output from the light-emitting unit 330 by controlling the driving current of each LED of the light-emitting unit 330.

Thus, in an embodiment, the processor 390 may control the light-emitting device 300 including a plurality of LEDs and may form a predetermined text, image, or video.

The light-emitting device 300 including the above configuration may operate according to at least one piece of data stored in the storage unit 340 under the control of the processor 390.

In addition, in an embodiment, the light-emitting device 300 may emit light according to the control signal received from the transmitter 200 based on the light-emitting unit 330.

In this connection, the control signal may include command data that is activated to emit light based on the library and/or scenario pre-stored in the light-emitting device 300 or light emission pattern information included in the control signal.

Furthermore, in an embodiment, the light-emitting device 300 may sense motion and acceleration of the light-emitting device 300 based on the sensor unit 370.

Furthermore, in an embodiment, the light-emitting device 300 may recognize ambient sounds based on the sensor unit 370 and control light emission to match the recognized sounds. For example, the louder the recognized sound, the brighter the light emission.

Furthermore, in an embodiment, the light-emitting device 300 may transfer data sensed by the sensor unit 370 and/or the input interface to another device (for example, the central control terminal 100 and/or the transmitter 200).

Furthermore, in an embodiment, the light-emitting device 300 may operate passively based on a command signal (control signal) delivered from the outside. In another embodiment, the light-emitting device 300 may operate on its own based on the input interface 380 (for example, a predetermined button).

The concept of operation may vary and is not limited to any one concept. For example, various types of operation are possible depending on the type of light-emitting device 300 (for example, cheering tools, light-emitting device, lighting stick, wearable band, and/or wearable device), such as light-emitting operation, sound-generating operation, and mechanical operation.

Furthermore, in another embodiment, the light-emitting device 300 may emit light according to the light emission pattern information of the library pre-stored as a default for each light-emitting device 300.

As described above, various embodiments may exist, but in the following embodiments, the light-emitting device 300 will be described based on emitting light according to a control signal from the central control terminal 100 and/or the transmitter 200 in a state in which there is no previously stored prior information.

### Method for Producing Field Performance for Plurality of Light-Emitting Devices

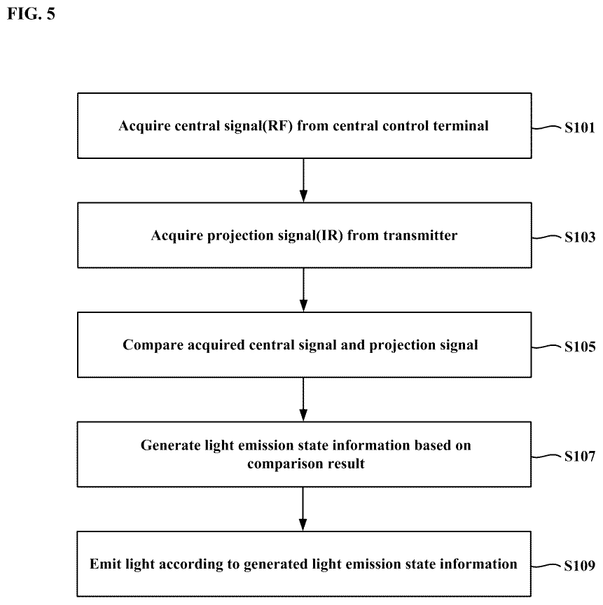

Hereinafter, a method for producing a field performance for a plurality of light-emitting devices by a performance production system according to an embodiment of the present disclosure will be described in detail with reference to the attached FIGS. 5 to 8.

FIG. 5 is a flowchart illustrating a method for producing a field performance for a plurality of light-emitting devices according to an embodiment of the present disclosure.

Referring to FIG. 5, in an embodiment, the plurality of light-emitting devices 300 may acquire, via the first communication method, the central signal transmitted from the central control terminal 100 (S101). In an embodiment, the central control terminal 100 may generate, or acquire from an external producer terminal, a first control signal including at least one data set in which light emission pattern information is specified for each piece of transmitter identification information, and may transmit this first control signal as a central signal to the plurality of light-emitting devices.

The central signal, according to an embodiment, may be a control signal that specifies how at least one light-emitting device 300 located within a performance hall will emit light when the relevant light-emitting device 300 falls within a specific zone (in an embodiment, the shape of the control signal emitted by the transmitter 200).

To this end, in an embodiment, the central signal may include transmitter identification information and/or light emission pattern information.

In this connection, the transmitter identification information may be information indicating a unique transmitter serial number (or projector serial number) pre-stored for each transmitter 200.

In addition, the light emission pattern information may be information on a light emission pattern that determines in what format the light-emitting device 300 that will operate according to a control signal will emit light for a predetermined period of time.

In an embodiment, the light emission pattern may refer to a light emission form in which the light-emitting device 300 operates according to components including a light emission mode (for example, ON mode, OFF mode, and/or sound recognition mode), light emission color, light emission time, light emission brightness, and/or light emission effect.

Herein, the light emission effect may refer to a light emission form in which the components are set to change within a predetermined time to create a dynamic visual effect.

For example, the light emission effect may include 1) a blinking effect that quickly flashes a light-emitting unit 330 by setting the light emission differently for each time zone within a predetermined period of time, 2) a gradation effect in which the light emission color is set differently for each time zone within a predetermined period of time and gradually changes, and 3) a fade in/out effect in which the brightness is set differently for each time zone and gradually decreases or brightens.

Since the central signal containing the transmitter identification information and/or light emission pattern information is an RF signal, it may be transferred to the light-emitting devices 300 within a wider range (in an embodiment, including all light-emitting devices within a performance hall) than the projection signal, as long as the frequency matches.

In other words, in an embodiment, the central control terminal 100 may transfer, to at least one transmitter 200 and/or light-emitting device 300 using the first communication method, a central signal causing the light-emitting devices 300 located within the zone, form, and/or shape (hereinafter, “shape”) formed by the control signal emitted by the relevant transmitter based on the transmitter identification information to emit light based on the relevant light emission pattern information. Hereinafter, in an embodiment, the “shape” may refer to the control signal range formed by the control signal emitted by the predetermined transmitter 200.

In this manner, in an embodiment, the light-emitting device 300 may acquire the central signal which is transmitted from the central control terminal 100 using the first communication method and includes the transmitter identification information and/or light emission pattern information.

In addition, in an embodiment, the light-emitting device 300 may acquire a projection signal transferred from the transmitter 200 using the second communication method (S103).

In an embodiment, a plurality of transmitters 200 may be installed at different locations depending on the structure and size of a performance hall. This is because the IR signal, which is the projection signal of the second communication method emitted by the transmitter 200, has a shorter communication range than the RF signal, which is the central signal of the first communication method, and thus is suitable for short-range communication.

In addition, each transmitter 200 pre-stored with unique transmitter identification information may emit one projection signal per transmitter 200.

The projection signal, according to an embodiment, may be a control signal that defines a shape as a predetermined light-emitting target range (in other words, a control signal range) for the light-emitting devices 300 located within the relevant shape preset in the transmitter 200 by mapping a frame of a predetermined image.

To this end, in an embodiment, the projection signal may include transmitter number information.

In other words, in an embodiment, the transmitter 200 may determine that a signal radius (or the area formed by the light-emitting devices 300 located within the relevant radius) is an n-th shape by emitting the projection signal to at least one light-emitting device 300 located within the preset signal radius.

In other words, when the central signal emitted by the central control terminal 100 is a signal for determining the n-th shape of the “light emission pattern,” the projection signal may be viewed as a signal for defining that the signal range receiving the control signal from the transmitter 200 is the “n-th shape.”

For example, the central control terminal 100 may emit the central signal including data indicating that “The light-emitting devices 300 within the first shape emit light according to light emission pattern information A” to the light-emitting devices 300 within a performance hall. The transmitter 200 may emit the projection signal including data indicating that “This signal range corresponds to the first shape” to the light-emitting device 300 located within a preset signal range.

In this manner, in an embodiment, the light-emitting device 300 may acquire at least one projection signal transferred using the second communication method from at least one transmitter 200.

In an embodiment, the central signal may be utilized for static production, such as producing a background color without setting the transmitter identification information, and the projection signal may be utilized for dynamic production, such as emitting light in a specific shape (for example, text and/or figure) within a specific signal range. In other words, when the central signal sets the transmitter identification information, dynamic production may be performed according to the projection signal.

Accordingly, the central signal has the advantage of being capable of wide-range propagation and large-scale data transmission, but has the disadvantage of being difficult to selectively restrict to a small number of specific light-emitting devices. In contrast, the projection signal has the advantage of being able to specify a target, but has the disadvantage of not being capable of wide-range propagation and large-scale data transmission. In other words, in an embodiment, the two signals may have a relationship in which their strengths and weaknesses complement each other.

In addition, in an embodiment, the light-emitting device 300 may compare the acquired central signal and projection signal (S105). Although the comparison in step S105 is performed at each light-emitting device 300 based on the actually received signals, the comparison rule and the light emission state information to be applied for each combination of the central signal 400 and the projection signal 500 are predefined by the central control terminal 100.

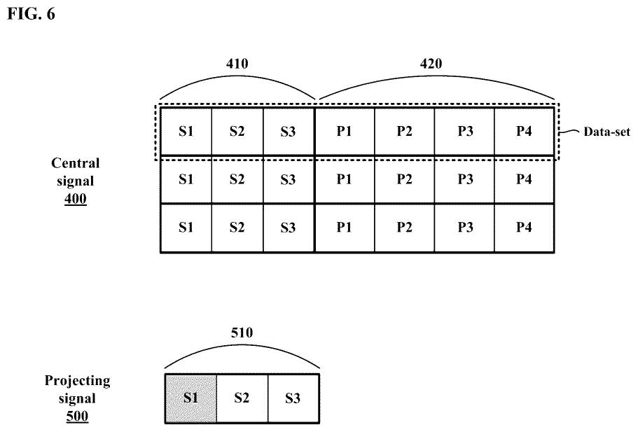

FIG. 6 is a diagram illustrating a central signal and a projection signal according to an embodiment of the present disclosure.

The central signal, projection signal, and/or the light emission state information to be described later, according to an embodiment, may be implemented in the form of an array, table, queue, and/or matrix including a plurality of data structures. However, for convenience of explanation, the description will be made based on implementation in the form of data having a predetermined structure as illustrated in FIG. 6.

In addition, in an embodiment, the central signal, the projection signal, and/or the light emission state information may include additional data (for example, a header, a block including instructions, and/or a trailer) (not shown) for identification and accuracy of data.

Referring to FIG. 6, a central signal 400 according to an embodiment may include transmitter identification information 410 and/or light emission pattern information 420.

In an embodiment, the central control terminal 100 may transfer, to the light-emitting device 300, the central signal 400 in which the unique serial number (or transmitter number) of the transmitter 200 that will emit a projection signal controlling the light emission of light with the light emission pattern information 420 is displayed in the transmitter identification information 410.

To this end, the transmitter identification information 410 may include at least one number space S1, S2, and S3.

In an embodiment, the central control terminal 100 may specify the transmitter (and/or projector) by inserting a predetermined value indicating the unique serial number (or projector number) of the transmitter 200 into the number space S1, S2, and S3.

In this connection, the unique serial number of the transmitter 200 input to the number space S1, S2, and S3 may be displayed in a manner in which the transmitter number is directly input and/or in a manner in which the number is inserted in the number space corresponding to the transmitter number.

For convenience of description, each number space S1, S2, and S3 is assumed to correspond to one transmitter number on a one-to-one basis. In addition, the description is made assuming that the number of transmitters installed in a performance hall is three, and accordingly, the number space configuring the transmitter identification information is composed of three, but the number thereof may be greater or less than the number illustrated. In addition, although it is illustrated that one piece of light emission pattern information 420 corresponds to each piece of transmitter identification information 410, an embodiment in which transmitter numbers are overlapped may also be possible to enable the plurality of transmitters to emit light with the same light emission pattern information 420.

For example, in order for the central control terminal 100 to control a first transmitter corresponding to the first number space S1 to emit a projection signal, the transmitter identification information 410 may be displayed by inserting “1” into the first number space S1 and not inserting a value or inserting “0” into the second and third number spaces S2 and S3.

In other words, in order for the central control terminal 100 to specify the first transmitter, the transmitter identification information 410 in which the values “1/0/0” are sequentially input may be transferred to the light-emitting device 300 as the central signal 400.

In addition, there may be a case where the central control terminal 100 specifies the plurality of transmitters at once. When the light emission pattern information 420 matched to one transmitter identification information 410 is regarded as one data set, in an embodiment, the central control terminal 100 may transfer the central signal 400 including a plurality of data sets.

Returning back, in an embodiment, the central control terminal 100 may transfer, to the light-emitting device 300, the central signal 400 displaying the light emission pattern information 420 that specifies how the light-emitting devices 300 that received a signal from a specified transmitter according to the aforementioned procedure will emit light.

The light emission pattern information 420 may be information indicating a real-time state (for example, light emission pattern) of the light-emitting device 300 and/or a sequence of real-time state changes.

To this end, in an embodiment, the light emission pattern information 420 may include at least one light emission pattern space P1, P2, P3, and P4.

In an embodiment, the central control terminal 100 may determine the light emission pattern by inserting a predetermined value representing the light emission pattern into the light emission pattern space P1, P2, P3, and P4.

For convenience of description, each light emission pattern space P1, P2, P3, and P4 is described as having a one-to-one (1:1) correspondence with one light emission pattern component, for a total of four. However, the number thereof may be greater or less than the number illustrated.

In detail, each light emission pattern space P1, P2, P3, and P4 may be inserted with information representing the light emission pattern components (in other words, category), including light emission color, light emission brightness, light emission time, and/or light emission effect, as values that the light-emitting device 300 may implement.

For example, the light emission color may be inserted into the first light emission pattern space P1, the light emission brightness may be inserted into the second light emission pattern space P2, the light emission time may be inserted into the third light emission pattern space P3, and the light emission effect may be inserted into the fourth light emission pattern space P4.

In an embodiment, the light emission color may be expressed by assigning a series of numbers to preset color-specific channel values through computations. For example, a large difference in the color-specific channel values may result in a highly saturated color, while a small difference in the color-specific channel values may result in a less saturated color.

As another example, the light emission color may be expressed as a preset color code (for example, red, blue, or purple) representing a predetermined color. As yet another example, the light emission color may be expressed as a serial number pre-assigned to each predetermined color for convenience or security.

For convenience of description, in the examples described below, the light emission colors are described based on the color codes pre-set in the alphabet. In addition, the data structure illustrated in FIGS. 6 to 8 is implemented virtually to help understand what data the central signal and projection signal exchange, so the structure of the data actually transmitted and received is not limited to what is illustrated.

In addition, the light emission brightness may be expressed as a brightness value with values of 0, 1, 2, . . . n, with higher values indicating brighter brightness. In addition, the light emission time may be expressed as a time value, with values such as 0:01, 0:02, . . . , m:s, with higher values indicating a longer length of time. In addition, the light emission effect may be expressed as values that refer to each of blink, gradation, fade in, and fade out.

In other words, the central control terminal 100 may include the light emission pattern information 420 in the form of “RED/50/0:10/Blink” in the central signal 400 and transfer the same to the light-emitting device 300.

Accordingly, in an embodiment, the light-emitting device 300 may acquire the central signal 400 including the transmitter identification information 410 and/or the light emission pattern information 420.

In addition, the projection signal 500 according to an embodiment may include transmitter number information 510.

In an embodiment, the transmitter 200 may emit the projection signal 500 including the transmitter number information 510 pre-matched to the relevant transmitter to at least one light-emitting device 300 within the signal range of the relevant transmitter.

The contents of the transmitter number information 510 are the same as the contents of the transmitter identification information 410 described above, and thus the descriptions thereof are applied and thus are omitted, and only the other portions are described.

In detail, in an embodiment, when the light-emitting device 300 receives one projection signal from the first transmitter, the first transmitter number may be inserted into the first number space S1 corresponding to the first transmitter.

In addition, the number of transmitter numbers filled in the number space S1, S2, and S3 of the transmitter identification information 410 may be different depending on how many projection signals the light-emitting device 300 receives.

For example, “1” may be inserted into the first number space S1, and “0” may be inserted into the second and third number spaces S2 and S3.

In other words, when the light-emitting device 300 exists at a location where the signal ranges of the plurality of transmitters overlap, a plurality of transmitter numbers may be inserted into each of the number spaces S1, S2, and S3.

Accordingly, in an embodiment, the light-emitting device 300 may acquire the projection signal 500 in which a predetermined value is inserted into the number space corresponding to the transmitter.

Illustratively, for convenience of description, in FIGS. 6 to 8, a predetermined shade is illustrated to be displayed in a portion where the transmitter identification information of the currently receiving central signal 400 and the transmitter number information of the projection signal 500 match.

To summarize, in an embodiment, the light-emitting device 300 may be controlled to emit light by the central control terminal 100 depending on whether the transmitter identification information 410 of the central signal 400 and the transmitter number information 510 of the projection signal 500 as described above match.

In addition, in an embodiment, the central control terminal 100 may generate light emission state information 600 based on the comparison result of the central signal 400 and/or the projection signal 500 (S107). The central control terminal 100 may insert the generated light emission state information 600 into the first control signal and broadcast the updated first control signal to the plurality of light-emitting devices 300 by the first communication method.

In detail, in an embodiment, the central control terminal 100 may generate the light emission state information 600 that causes light emission according to the light emission pattern information 420 of the central signal 400 when the transmitter identification information 410 included in the central signal 400 and the transmitter number information 510 included in the projection signal 500 match.

Herein, the light emission state information according to an embodiment may be information that determines how at least one light-emitting device 300 receiving the central signal and the projection signal will emit light. In this connection, the light-emitting device 300 may receive one of the central signal or the projection signal first, or may receive both signals simultaneously.

The light emission state information may be generated by determining the values of a plurality of parameters (in an embodiment, light emission pattern components) depending on whether the transmitter numbers included in the acquired central signal and projection signal are the same and the number of acquired projection signals.

In this connection, in an embodiment, the type of light emission state information 600 generated may be different depending on how many projection signals 500 the light-emitting device 300 receives.

In an embodiment, when it is assumed that n numbers of transmitters are installed in a performance hall, the light-emitting device 300 may acquire 0 to n projection signals 500.

In other words, in an embodiment, when the light-emitting device 300 is located within a predetermined overlapping range, a plurality of projection signals 500 may be acquired.

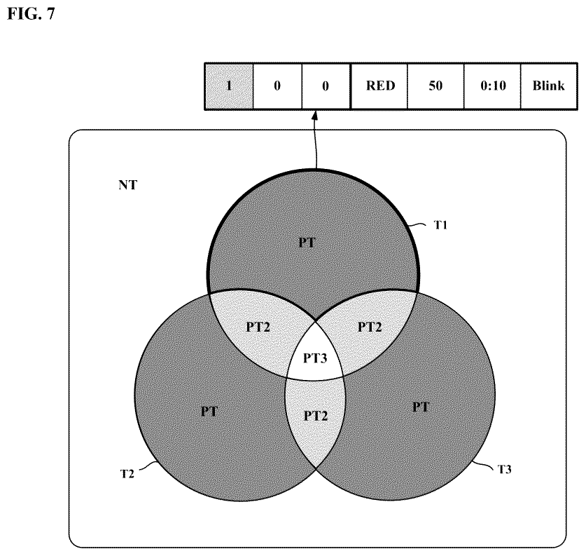

FIG. 7 is a diagram illustrating an overlapping range for receiving a plurality of projection signals according to an embodiment of the present disclosure.

In detail, FIG. 7 illustrates an example in which the first transmitter emits a first projection signal to a first shape T1, a second transmitter emits a second projection signal to a second shape T2, and a third transmitter emits a third projection signal to a third shape T3.

In addition, in an embodiment, the range that does not receive the projection signal is referred to as other range NT. In addition, the range that receives only one projection signal is referred to as a single range PT. In addition, the range that receives two projection signals is referred to as a double overlapping range PT2. In addition, the range that receives three projection signals is referred to as a triple overlapping range PT3.

In other words, in an embodiment, the single range PT is a range that receives only one of the first to third projection signals. In addition, in an embodiment, the double overlapping range PT2 is a range that receives two signals among the first to third projection signals. In addition, in an embodiment, the triple overlapping range PT3 is a range that receives all three signals of the first to third projection signals.

Referring to FIG. 7, in an embodiment, the light-emitting device 300 may acquire 0 to n projection signals 500 depending on a location.

In detail, in an embodiment, when the light-emitting device 300 is located in the other range NT and receives 0 projection signals 500, the light emission state information 600 is not generated, and thus the light-emitting device may not emit light.

However, in the case where the central signal 400 does not set the transmitter identification information 410 and sets only the light emission pattern information 420, the light-emitting device 300 in an embodiment may emit light with the relevant light emission pattern information 420.

In an embodiment, in the case where the light-emitting device 300 is located in a range PT, PT2, and PT3 that receives at least one projection signal 500 excluding the other range NT, even when the light emission pattern component 420 of the central signal 400 has set the background color, the light-emitting device 300 may be controlled by the central control terminal 100 to emit light with priority given to the acquired projection signal 500.

In an embodiment, when the light-emitting device 300 is located in the single range PT and receives one projection signal 500, the light-emitting device 300 may be controlled by the central control terminal 100 to emit light with the light emission state information 600 that is identical to the light emission pattern information 420 of the relevant central signal 400.

In this connection, the transmitter identification information 410 included in the central signal 400 and the transmitter number information 510 included in the projection signal 500 may be the same.

For example, when the central signal 400 includes the transmitter identification information 410 of “1, 0, 0” and the light emission pattern information 420 of “RED/50/0:10/Blink” and the projection signal 500 includes the transmitter number information 510 of “1, 0, 0,” the light-emitting device 300 may emit light with the light emission pattern information 420 of “RED/50/0:10/Blink.”

In addition, in an embodiment, when the light-emitting device 300 is located in the double overlapping range PT2 and receives two projection signals 500, the light-emitting device 300 may be controlled by the central control terminal 100 to emit light with new light emission state information 600 by combining the light emission pattern information 420 of the two central signals 400. Similarly, when the light-emitting device 300 is located in the triple overlapping range PT3 and receives three projection signals 500, new light-emitting state information 600 may be generated.

Also in this connection, the transmitter identification information 410 of each data set may be identical to the transmitter number information 510 included in the projection signal 500.

In other words, in an embodiment, the light-emitting device 300 may be controlled by the central control terminal 100 based on the light emission state information 600 generated to emit light differently depending on the overlapping range in which the light-emitting device 300 is located.

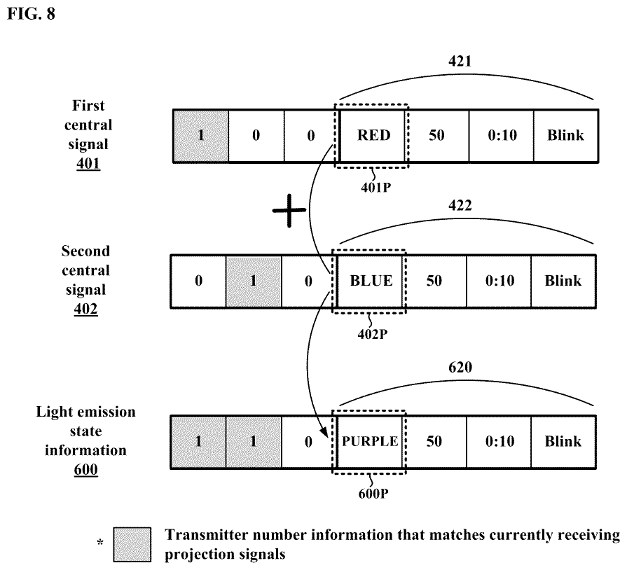

FIG. 8 is a diagram illustrating light emission state information generated by acquiring a plurality of projection signals according to an embodiment of the present disclosure.

Referring to FIG. 8, in an embodiment, the light-emitting device 300 may acquire a first central signal 401 and/or a second central signal 402 from the central control terminal 100.

In this connection, the first central signal 401 may include transmitter identification information that specifies the first transmitter, and the second central signal 402 may include transmitter identification information that specifies the second transmitter.

In addition, in an embodiment, the light-emitting device 300 may acquire a first projection signal from the first transmitter and a second projection signal from the second transmitter. In other words, two projection signals may be acquired simultaneously.

Accordingly, referring again to FIG. 7, it is assumed that the light-emitting device 300 is located in the double overlapping range PT2 where a first range T1 and the second range T2 overlap.

In an embodiment, the central control terminal 100 may generate, match, and store the light emission state information in advance for each combination of central signals in order to control the light emission of the light-emitting devices 300 located in such an overlapping range.

To this end, in an embodiment, the central control terminal 100 may calculate the median value of a first light emission pattern component 401P of the first central signal (hereinafter, the first light emission element) and a second light emission pattern component 402P of the second central signal (hereinafter, the second light emission element). At this time, the decimal value may be rounded off to an integer.

In addition, it is assumed that the light emission pattern components (in other words, categories such as “light emission color”) of the first light emission element and the second light emission element are the same. In addition, it is assumed that the values of the remaining light emission pattern components are the same.

For example, since the first light emission element is an “light emission color,” the median value may be calculated by computing the channel value of the light emission color code included in each central signal. For example, when the first light emission element 401P includes a color code representing red and the second light emission element 402P includes a color code representing blue, the calculated median value may be a color code representing purple.

Accordingly, in an embodiment, the central control terminal 100 may generate the light emission state information 600 by inserting the calculated median value into a first light emission pattern component 600P (hereinafter, the first combination element).

In an embodiment, even when the light-emitting device 300 is located in the triple overlapping range PT3 and receives three projection signals 500, the central control terminal 100 may generate the light emission state information 600 by calculating the median value of the first to third light emission elements and using the calculated median value as the first combination element.

As such, when the light-emitting device 300 acquires the central signal 400 and/or the projection signal 500, in an embodiment, the central control terminal 100 may control the light emission of the plurality of light-emitting devices 300 according to the generated light emission state information 600.

In summary, in an embodiment, when the light-emitting device 300 receives a projection signal from the plurality of transmitters 200 and receives a central signal including one of the light emission pattern information and/or light emission state information from the central control terminal 100, the light-emitting device 300 may emit light according to the central signal and/or light emission state information that is identical to a combination of the projection signals that were being received.

In detail, in an embodiment, the central control terminal 100 may set (group) two or more data sets as integrated data according to a plurality of combinations that may be calculated with the transmitter identification information depending on the number of cases.

For example, assuming that there are first to third transmitters, there are three single data sets including a single transmitter, and the data sets may be set as integrated data 1 including the first and second transmitters, integrated data 2 including the first and third transmitters, integrated data 3 including the second and third transmitters, and integrated data 4 including all of the first to third transmitters.

In addition, in an embodiment, the central control terminal 100 may extract, for each data set, the light emission pattern component value of the same category among the light emission pattern information included in at least two data sets of the set integrated data.

In addition, in an embodiment, the central control terminal 100 may generate light emission state information by calculating the median value of the extracted light emission pattern component values and inserting the extracted median value into the light emission pattern component of the same category.

In the above description, it is described that the central control terminal 100 collects a plurality of central signals and/or projection signals to generate the light emission state information 600 including the combination element and transfers the same to the light-emitting device 300. However, an embodiment in which the light-emitting device 300 generates the light emission state information 600 may also be possible.

In addition, in an embodiment, the light-emitting device 300 may emit light under the control of the central control terminal 100 according to the light emission state information 600 generated by the central control terminal 100 (S109).

In a first embodiment, when the light-emitting device 300 receives 0 projection signals, the central control terminal 100 may control the light-emitting device 300 not to emit light or to emit light according to a light emission pattern (for example, background color) determined by the light emission pattern information 420 included in the central signal 400.

In a second embodiment, when the light-emitting device 300 receives one projection signal, the central control terminal 100 may control the light-emitting device 300 to emit light according to the light emission pattern information 420 when the transmitter numbers of the central signal 400 and the projection signal 500 match.

In a third embodiment, when the light-emitting device 300 receives two or more projection signals, the central control terminal 100 determines the combination element that calculates a median value based on the light emission element included in the central signal 400 whose transmitter numbers match, and generates the light emission state information 600 including the determined combination element to control the light-emitting device 300 to emit light according to the relevant light emission state information 600.

In an embodiment, the central control terminal 100 may perform a field production for the plurality of light-emitting devices 300 by transmitting the central signal that drives at least one library pre-stored in each light-emitting device 300.

Herein, the library may refer to a pre-specified data set of resources for frequently used light emission pattern information in performances. This library may include basic effects, animation effects, and/or custom images. For example, the library may include a data set including a first basic effect that flashes like a lit candle, a first animation effect that slides from left to right, and a first custom image representing the logo of a first artist group.

In addition, since the library is basically stored in the light-emitting device 300 without going through a separate download process, it may be executed automatically or manually according to control signal acquisition or user input.

Accordingly, at least one light-emitting device 300 receiving the transmitted central signal may be controlled to emit light according to a commanded library among the pre-stored libraries.

In this connection, the light-emitting device 300 may receive the central signal and the projection signal simultaneously. The light-emitting device 300 that receives both of the signals may be located within a predetermined projection signal shape.

Hereinafter, the area projected by a first projector is referred to as a first projecting shape, the area projected by an n-th projector other than the first projector is referred to as a second projecting shape, and the remaining area other than the areas projected by the first to n-th projectors is referred to as a third projecting shape.

In an embodiment, the central control terminal 100 may be controlled by differentiating the light-emitting devices 300 located in the first and second projecting shapes. In this connection, since a default value may be set based on the central signal for the third projecting shape outside the control area, the light-emitting devices 300 within the first to third projecting shapes may substantially be controlled differently.

In detail, in an embodiment, the central control terminal 100 may control the light emission of the light-emitting devices 300 located in the first and second projecting shapes based on the central signal in which the transmitter identification information is inserted. In other words, in an embodiment, the central control terminal 100 may control the light emission of the light-emitting device 300 located in the third projecting shape by transmitting the central signal without inserting the transmitter identification information.

As such, in an embodiment of the present disclosure, based on the dual communication structure described above, more specific and advanced dynamic productions may be performed, such as implementing chain effects across a plurality of zones within a performance hall.

### Method and System for Performing Dynamic Production Based on Plurality of Communication Methods

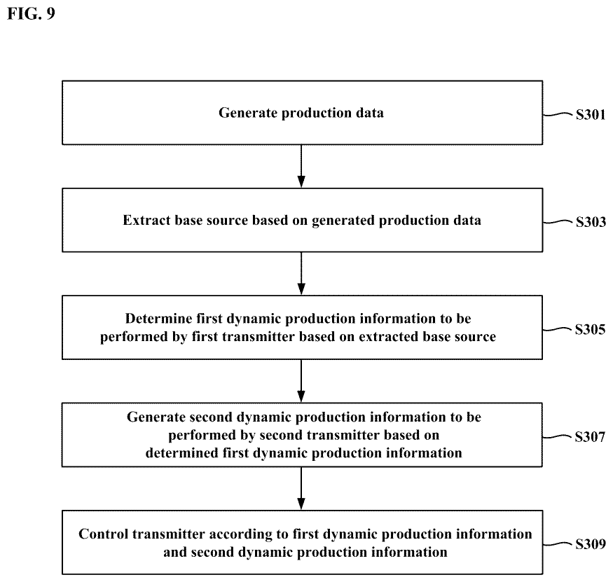

Hereinafter, a method for producing a field performance for a plurality of light-emitting devices by a performance production system according to an embodiment of the present disclosure will be described in detail with reference to the attached FIGS. 9 to 14.

FIG. 9 is a flowchart illustrating a method for performing a dynamic production based on a plurality of communication methods according to an embodiment of the present disclosure.

Referring to FIG. 9, in an embodiment, the central control terminal 100 may generate production data (S301).

Herein, the production data according to an embodiment may refer to data that defines in advance various light emission patterns (for example, light emission color, light emission effect) that the light-emitting devices 300 are required to emit light in each seat in a performance hall in order to produce a unified performance by zone, seat, or music.

Based on such production data, a performance producer according to an embodiment may perform static production by designating a predetermined designated zone and/or seat, or perform dynamic production by implementing movement of text or patterns using all seats in a performance hall.

In detail, in an embodiment, the central control terminal 100 may generate production data by at least one of a direct input method for the central control terminal 100 of a performance producer based on the central control terminal and/or an indirect input method acquired through linkage with another terminal.

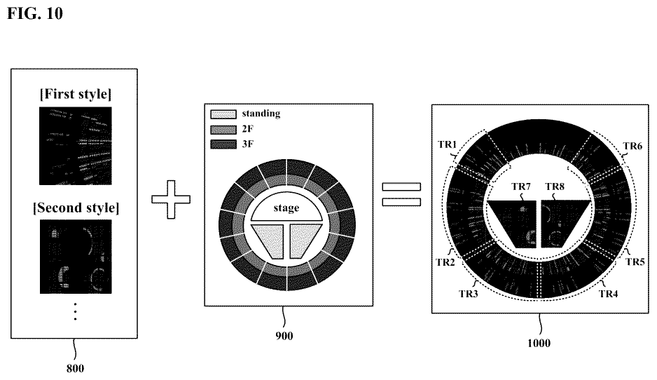

FIG. 10 is an example of production data according to an embodiment of the present disclosure.

Referring to FIG. 10, in an embodiment, the central control terminal 100 may generate production 1000 based on a performance production interface.

In this connection, the production data 1000 may apply at least one of the production styles included in a production file 800 to each zone included in a seating chart 900 that is identical to the internal structure of a performance hall. In other words, at least one production style may be applied to some or all seats in the performance hall based on the production file 800.

Accordingly, in an embodiment, the central control terminal 100 may acquire and/or generate the production file 800 including at least one production style.

In addition, in an embodiment, the central control terminal 100 may acquire and display the seating chart 900 based on the performance production interface.

In addition, in an embodiment, the central control terminal 100 may determine the production style to be applied to at least one zone (for example, TR1 to TR8) included in the seating chart 900.

In other words, in an embodiment, the central control terminal 100 may generate the production data 1000 that determines a predetermined production style for each of a plurality of zones TR1 to TR8.

In this connection, each of the plurality of zones TR1 to TR8 may be pre-matched with one transmitter 200 that emits a projection signal to the corresponding zone.

In addition, in an embodiment, the central control terminal 100 may extract a base source based on the generated production data (S303).

Herein, the base source according to an embodiment may refer to a default value of a light emission pattern component (for example, light emission color, light emission brightness, light emission time, and/or light emission effect) commonly used in all of the plurality of zones included in the production data 1000.

For convenience of description, in an embodiment, the production data 1000 is described based on the fact that the light emission color is commonly applied to all zones and only the light emission pattern is different, but at least one element among the light emission pattern components may be extracted as the base source.

In an embodiment, the central control terminal 100 may extract a first light emission pattern component commonly applied to all zones from the production data 1000. In this connection, there may be at least one first light emission pattern component.

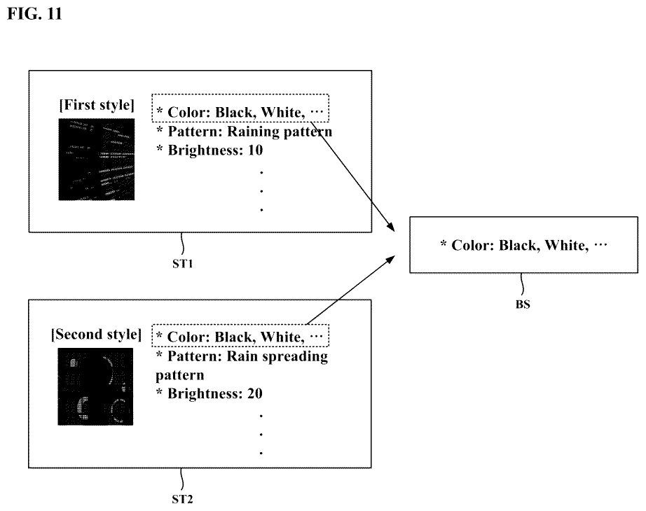

FIG. 11 is an example of a diagram illustrating a base source according to an embodiment of the present disclosure. For example, in FIG. 11, the first production style of “rain falling production” and the second production style of “rain spreading production” are illustrated.

Referring to FIG. 11, in an embodiment, the central control terminal 100 may extract a first light emission pattern component from the production data 1000 including at least one production style ST1 and ST2.

For example, the light emission color of the first production style ST1 may be composed of a first color value (for example, black) and a second color value (for example, white), and the light emission pattern may be composed of a first pattern value (for example, a raining pattern).

In addition, the light emission color of the second production style ST2 may be composed of the first color value (for example, black) and the second color value (for example, white), and the light emission pattern may be composed of a second pattern value (for example, a rain spreading pattern).

In other words, since the light emission colors of the first production style ST1 and the second production style ST2 included in the production data 1000 are the same and only the light emission patterns are different, the central control terminal 100 may extract the “light emission color” including the first color value (for example, black) and the second color value (for example, white) commonly applied to the two styles as the first light emission pattern component.

In other words, in an embodiment, the central control terminal 100 may determine at least one setting value included in the extracted first light emission pattern component as a base source BS.

In addition, in an embodiment, the central control terminal 100 may determine first dynamic production information to be performed by the first transmitter based on the extracted base source (S305).

In this specification, the dynamic production information matched to the first transmitter is referred to as the first dynamic production information, and the dynamic production information matched to the n-th transmitter is referred to as the n-th dynamic production information.

Herein, the dynamic production information according to an embodiment may set a dynamic production sequence in which the moving head of one transmitter 200 moves along a predetermined dynamic path for a predetermined period of time.

The dynamic production information may include an angle sequence that specifies a setting value for an angular change of a first transmitter moving head for a predetermined period of time and/or a speed sequence that specifies a setting value for a speed when the angle of the first transmitter moving head changes for a predetermined period of time.

In addition, the dynamic production information may further include a frame sequence that specifies a setting value for a change in a frame mapped to a projection signal emitted by the first transmitter for a predetermined period of time. In other words, in an embodiment, the dynamic production sequence may include an angular sequence, a speed sequence, and/or a frame sequence.

In addition, the predetermined period of time may be determined by time code information included in the central signal and/or the projection signal.

Accordingly, in order to set a dynamic path for the n-th transmitter according to the setting of the dynamic production sequence, in an embodiment, the central control terminal 100 may determine an angular sequence for the first transmitter.

In this connection, the angular sequence may include setting values for a basic angle, minimum angle, and/or maximum angle.

For example, the central control terminal 100 may determine a setting value for the first transmitter in which the basic angle is 50°, the minimum angle is 0°, and the maximum angle is 100°.

Accordingly, in an embodiment, the central control terminal 100 may control a tilting angle of the first transmitter at a desired angle.

In addition, in an embodiment, the central control terminal 100 may determine the speed sequence for the first transmitter.

In this connection, the speed sequence may include setting values for a basic speed, minimum speed, and/or maximum speed when the angle of the moving head changes.

For example, the central control terminal 100 may determine the same first speed sequence for the first to tenth transmitters sharing the first production style, and may determine the same second speed sequence for the eleventh to twentieth transmitters sharing the second production style, for consistent production.

Accordingly, in an embodiment, the central control terminal 100 may control the tilting speed of the first transmitter at a desired speed.

Accordingly, in an embodiment, the central control terminal 100 may generate a dynamic path for each of the n-th transmitters by determining the angular sequence and the speed sequence.

In other words, in an embodiment, the central control terminal 100 may easily set natural dynamic production for all seats by using the projection signals of the plurality of transmitters sharing the same base source BS by differently adjusting at least one setting value of the moving head of each transmitter for at least one transmitter disposed in a performance hall.

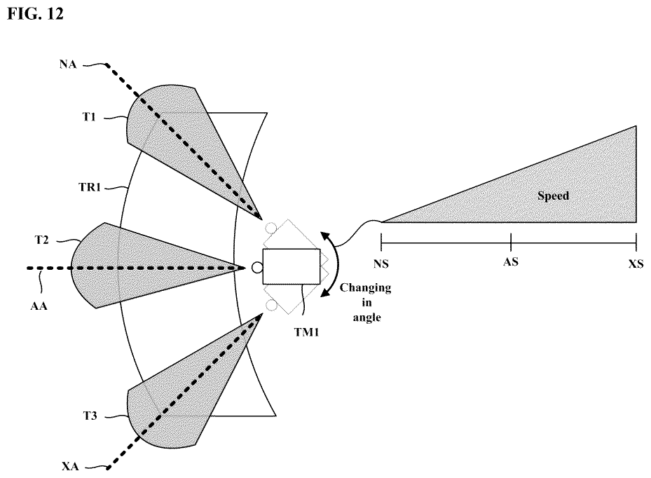

FIG. 12 is an example of a diagram illustrating dynamic production information according to an embodiment of the present disclosure. In detail, FIG. 12 illustrates an example in which a first transmitter TM1 emits a projection signal as much as the first shape T1 in a first zone TR1.

Referring to FIG. 12, in an embodiment, the central control terminal 100 may determine a basic angle AA, a minimum angle NA and/or a maximum angle XA to set the angle sequence of the first transmitter TM1 capable of changing the angle in up, down, left, and right directions.

In this connection, in an embodiment, the central control terminal 100 may set the basic angle AA differently for each of at least one transmitter disposed in a performance hall, depending on the location of the relevant transmitter.

In addition, in an embodiment, the central control terminal 100 may set the minimum angle NA, which is the angle at which dynamic production begins, and the maximum angle XA, which is the angle at which dynamic production ends, differently depending on the dynamic path that a performance producer wants to produce.

In addition, in an embodiment, the central control terminal 100 may determine a basic speed AS, a minimum speed NS and/or a maximum speed XS to set the speed sequence of the first transmitter TM1 when the angle changes.

In this connection, in an embodiment, the central control terminal 100 may map the same first speed to the minimum angle NA and maximum angle XA so as to move at a constant speed from the minimum angle NA to the maximum angle XA.

Accordingly, the performance producer may perform dynamic production in which the moving head moves at a constant speed when the angle changes.

In an embodiment, the central control terminal 100 may map different speeds to the minimum angle NA and maximum angle XA so as to move at a speed that gradually increases or decreases from the minimum angle NA to the maximum angle XA.

For example, when the minimum speed NS is mapped to the minimum angle NA and the maximum speed XS is mapped to the maximum angle XA, a performance producer may perform a dynamic production in which the moving head of the relevant transmitter moves at an increasingly faster speed from the minimum angle NA to the maximum angle XA.

In this way, in an embodiment, the central control terminal 100 may determine the first dynamic production information by mapping at least one element configuring the speed sequence to at least one setting value configuring the angle sequence of the first transmitter for a predetermined period of time.

In other words, in an embodiment, the central control terminal 100 may set a dynamic path for the first transmitter by determining the first dynamic production information.

In addition, in an embodiment, the central control terminal 100 may generate second dynamic production information to be performed by the second transmitter based on the determined first dynamic production information (S307).

In an embodiment, the second transmitter emits a projection signal as much as the second shape in a second zone adjacent to the first zone TR1.

In detail, in an embodiment, the central control terminal 100 may generate the second dynamic production information to be performed by the second transmitter so as to be connected with the first dynamic production information in order to apply a chain effect between adjacent zones.

The chain effect is an effect in which predetermined dynamic productions occur consecutively between adjacent zones, and may refer to, for example, an effect in which text or shapes move from zone to zone. The chain effect may include various productions. However, in this specification, for convenience of description, the chain effect is described based on the effect of a predetermined figure moving from zone to zone.

In order to implement this chain effect, in an embodiment, the central control terminal 100 may generate the second dynamic production information based on the setting values of elements configuring the angle sequence included in the first dynamic production information.

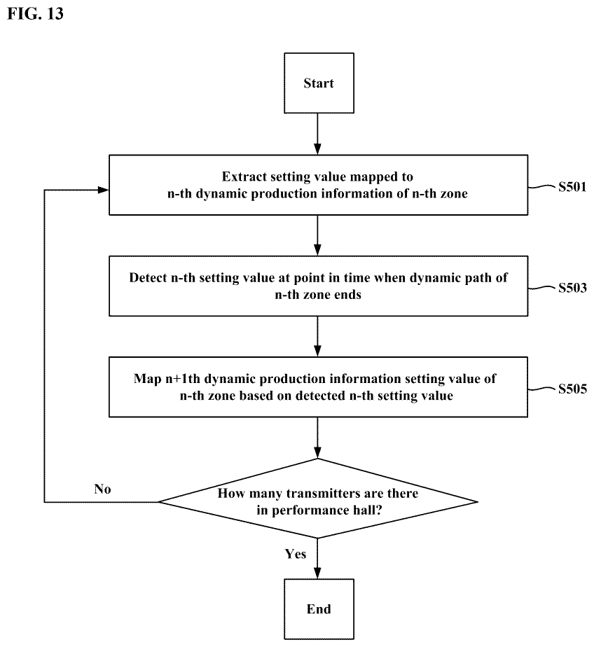

FIG. 13 is a flowchart illustrating a method for generating second dynamic production information based on first dynamic production information according to an embodiment of the present disclosure. FIG. 13 is illustrated as n-th dynamic production information and n+1-th dynamic production information. However, hereinafter, for convenience of description, the n-th dynamic production information is replaced with the first dynamic production information, and the n+1-th dynamic production information is replaced with the second dynamic production information.

Referring to FIG. 13, in an embodiment, the central control terminal 100 may extract a setting value mapped to the first dynamic production information (S501).

In detail, in an embodiment, the central control terminal 100 may extract the setting values of each element configuring the dynamic production sequence included in the first dynamic production information. Hereinafter, for the convenience of description, the description will be made based on extracting only the angular sequence and speed sequence from among the dynamic production sequences included in the dynamic production information.

In this connection, the setting values of each element configuring the dynamic production sequence may refer to the setting values of the basic angle AA, minimum angle NA, and maximum angle XA included in the angular sequence of the first dynamic production information, and the setting values of the basic speed AS, minimum speed NS, and maximum speed XS included in the speed sequence.

In addition, in an embodiment, the central control terminal 100 may detect a first setting value at a point in time when the dynamic path of the first zone ends (S503).

In this connection, the point in time when the dynamic path ends (hereinafter, the end point) may be the time code information at which the dynamic production information ends.

In addition, the first setting value at an end point in time may include an angular parameter and/or a speed parameter.

In other words, in an embodiment, the central control terminal 100 may detect the mapped angular parameter and/or speed parameter at the end point in time of the first zone.

In other words, in an embodiment, the central control terminal 100 may detect an end setting value of the first dynamic production sequence mapped to an end point in time of the first dynamic production information.

In addition, in an embodiment, the central control terminal 100 may map a second dynamic production information setting value of the second zone based on the detected first setting value (S505).

In detail, in an embodiment, the central control terminal 100 may determine the angular parameter and/or speed parameter mapped at the end point in time of the detected first zone as the angular parameter and/or speed parameter mapped at the start point in time of the dynamic path of the second zone (hereinafter, the start point in time).

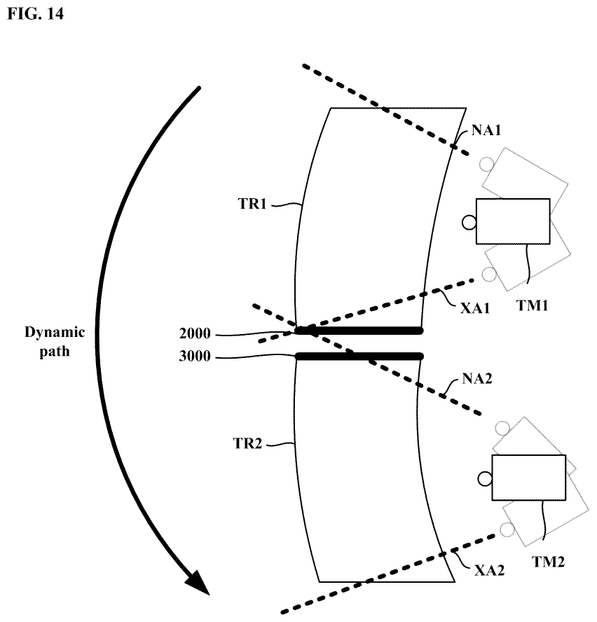

FIG. 14 is an example of implementing a chain effect based on the first dynamic production information and the second dynamic production information according to an embodiment of the present disclosure. In detail, FIG. 14 is an example in which the direction of dynamic production is determined in the direction of the arrow according to the dynamic production information setting of the transmitter.

Referring to FIG. 14, the first transmitter TM1 emits a projection signal to the first zone. In an embodiment, the central control terminal 100 may control the first transmitter TM1 to operate according to the first dynamic projection information in which the angle sequence is preset to move from a first minimum angle NA-1 to a first maximum angle XA-1.

A first line 2000 illustrated indicates a physical point corresponding to the angular parameter mapped at the end point in time of the first dynamic production information (in other words, the maximum angle XA-1 of the first dynamic production information).

In an embodiment, the central control terminal 100 may detect the maximum angle XA-1 of the first dynamic production information.

In addition, the second transmitter TM2 emits a projection signal to the second zone. In an embodiment, the central control terminal 100 may control the second transmitter TM2 to operate according to the second dynamic production information in which the angle sequence is preset to move from a second minimum angle (NA-2) to a second maximum angle XA-2.

A second line 3000 illustrated indicates a physical point corresponding to the angular parameter mapped at the start point in time of the second dynamic production information (in other words, the minimum angle NA-2 of the second dynamic production information).

In an embodiment, the central control terminal 100 may detect the minimum angle NA-2 of the second dynamic production information.

In this connection, in an embodiment, the central control terminal 100 may map the maximum angle XA-1 of the detected first dynamic production information and the minimum angle NA-2 of the second dynamic production information.

In other words, in an embodiment, the central control terminal 100 may determine the detected setting value as a starting setting value of the first dynamic production sequence mapped to the starting point in time of the second dynamic production information.

In other words, since the projection signal emission of the second transmitter begins as soon as the projection signal emission of the first transmitter ends according to the mapping between the pieces of dynamic production information, the chain effect can be implemented.

In this way, in an embodiment, the central control terminal 100 may implement the chain effect according to adjacent zones by generating the second dynamic production information based on the determined first dynamic production information.

In an embodiment, the central control terminal 100 may automate the generation of dynamic production information by copying the dynamic production sequences of the first dynamic production information and increasing/decreasing the setting values included in each sequence at a preset ratio. In this connection, the location coordinates of each transmitter 200 are pre-stored in the central control terminal 100. In an embodiment, the central control terminal 100 may extract the start setting value and the end setting value for the first dynamic production sequence of the first dynamic production information, calculate the increase/decrease rate of the end setting value compared to the start setting value, and determine the start setting value and the end setting value for the second dynamic production sequence of the second dynamic production information by reflecting the increase/decrease rate. In this connection, when the value of the calculated increase/decrease rate is 0, the start setting value and the end setting value of the second dynamic production sequence in the first dynamic production information may be used as the start setting value and the end setting value of the second dynamic production sequence in the second dynamic production information. However, when the value of the increase/decrease rate exceeds 0, the start setting value and the end setting value of the second dynamic production sequence of the second dynamic production information may be set to reflect the increase/decrease rate.

In addition, in an embodiment, the central control terminal 100 may generate n+1 dynamic production information based on the n-th dynamic production information in the same manner to perform a dynamic production for all seats in a performance hall.

In this connection, when the number of the n+1 dynamic production information generated becomes equal to the number of zones/transmitters existing in a performance hall, dynamic production information generation may be terminated.

In other words, in an embodiment, the central control terminal 100 may continue to generate dynamic production information between adjacent zones in the same manner until the number of the n+1 dynamic production information becomes equal to the number of zones/transmitters existing in a performance hall.

Returning back, in an embodiment, the central control terminal 100 may control the operation of each transmitter according to the first dynamic production information and the second dynamic production information (S309).

To this end, in an embodiment, the central control terminal 100 may detect the current angles of the first transmitter and the second transmitter.

In addition, in an embodiment, the central control terminal 100 may control to limit the driving of the first transmitter when the current setting value (for example, current angle) of the first transmitter in the first zone matches the angular parameter at the end point in time mapped to the first dynamic production information.

The limitation of the driving may include a process of setting all components of light emission pattern information being received by at least one light-emitting device 300 within the signal range of the first transmitter to 0 and/or a process of terminating the emission of the projection signal of the first transmitter.

In an embodiment, the central control terminal 100 may control the driving of the second transmitter to initiate when the current setting value (for example, current angle) of the second transmitter in the second zone matches the angular parameter at the start point in time mapped to the second dynamic production information.

The initiation of the driving may include a process of controlling at least one light-emitting device 300 existing within the signal range of the second transmitter to emit light according to the light emission pattern information being received.

In addition, in an embodiment, the central control terminal 100 may perform infinite looping for the same dynamic production by mapping the first generated dynamic production information and the last generated dynamic production information.

In addition, the transmitter 200 according to an embodiment may basically operate according to the generated dynamic production information, and may operate according to its own control when a direct input (for example, angular change, speed change, or frame change) to the relevant transmitter 200 is sensed.

In this way, in an embodiment, the central control terminal 100 may support the easy development of a dynamic production by generating the dynamic production information that changes only the angle, speed, and/or frame while sharing the base source.

Moreover, another embodiment of the present disclosure may generate and control a performance production in real time by immediately reflecting the intuitive input of a producer at a performance field.

### Method and System for Producing Real-Time Performance Based on Drawing Interface

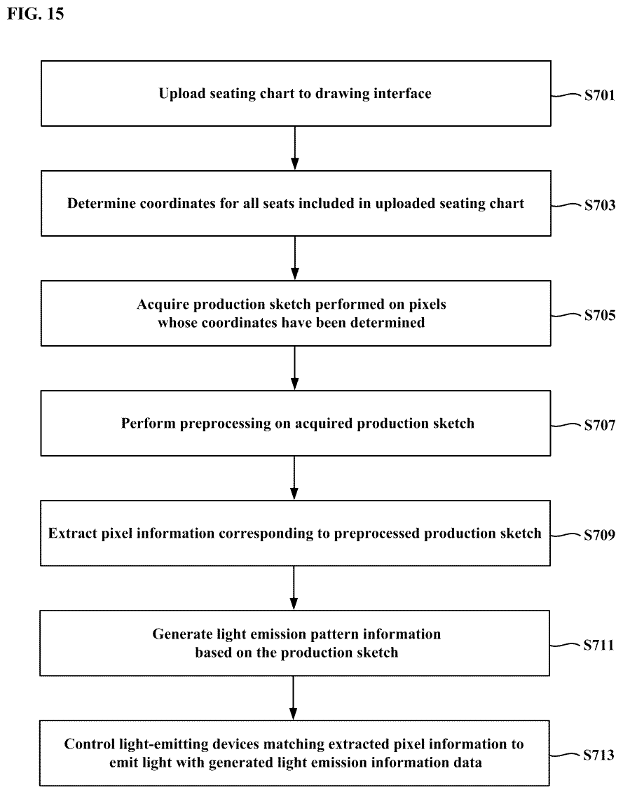

Hereinafter, a method for producing a real-time performance based on a drawing interface by a performance production system according to an embodiment of the present disclosure will be described in detail with reference to the attached FIGS. 15 to 19.

For convenience of description, the method for producing the real-time performance based on the drawing interface by the performance production system will be described as being subjectively performed by the application 111 of the central control terminal 100.

In the embodiment described below, the central control terminal 100 may mean a console mounted with a drawing touch pad, and accordingly, the application 111 may be a graphic file production application that generates production data based on a drawing input to the drawing touch pad.

FIG. 15 is a flowchart illustrating a method for producing a real-time performance based on a drawing interface according to an embodiment of the present disclosure.

Referring to FIG. 15, in an embodiment, the application may upload a seating chart to the drawing interface (S701).

Herein, the drawing interface according to an embodiment may refer to an interface used to develop and generate production data by overlapping the seating chart of a performance venue with a canvas, which is a work window for performing predetermined drawing work.

To this end, in an embodiment, the application 111 may pre-store data sets of seating charts corresponding to a performance venues and/or performance information (for example, artist name, or performance date) in advance.

A user (hereinafter, “producer”) who wishes to generate production data using the drawing interface may input the performance venue and/or performance information.

In an embodiment, the application 111 may extract a first seating chart corresponding to the input performance venue from among the pre-stored seating charts and display the same to overlap with the canvas.

Accordingly, in an embodiment, the application 111 may upload the seating chart to the canvas of the drawing interface.

In addition, in an embodiment, the application 111 may determine coordinates for all seats included in the uploaded seating chart (S703).

In detail, in an embodiment, the application 111 may pixelate all seats included in the uploaded seating chart on the canvas of the coordinate-based drawing interface and determine coordinates for each pixel.

More specifically, in an embodiment, the application 111 may determine coordinates for all seats by dividing the uploaded seating chart into a predetermined resolution to fit the canvas of the drawing interface and setting a coordinate axes.

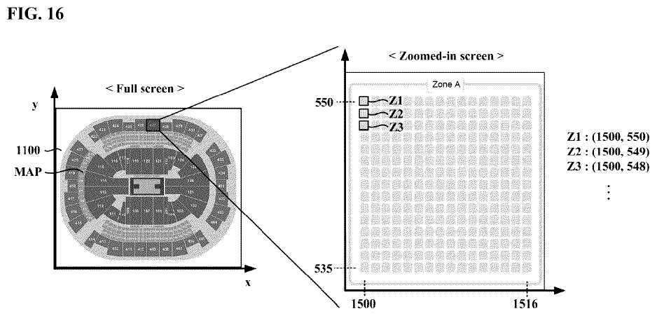

FIG. 16 is an example of determining coordinates for a seating chart uploaded to a drawing interface according to an embodiment of the present disclosure.

Referring to FIG. 16, in an embodiment, the application 111 may display a seating chart MAP on a canvas 1100 based on coordinates with x-axis and γ-axis values.

In this connection, the seating chart MAP may include at least one distinct zone. In addition, each zone may include a plurality of seats.

Accordingly, a mode that allows viewing zones all at once may be a full-screen mode, and a mode that allows viewing the seats included in a predetermined zone when the relevant zone is selected may be a zoomed-in mode.

In addition, in an embodiment, the application 111 may display all seats included in the seating chart MAP in a pixelated form. This pixelation may involve a process of simplifying the area occupied by one seat into a single dot. In addition, one seat may correspond one-to-one to one pixel. Herein, the pixel represents a logical grid unit within the application.

In other words, areas in the seating chart MAP without seats may not be pixelated but remain blank. For example, the application 111 may one-to-one match seat tables, such as “Section A, Row 10, Seat 3,” included in the seating chart, in pixels and/or coordinate units.

In addition, in an embodiment, the application 111 may determine coordinates for each pixelated seat based on the coordinate axes of the canvas included in the drawing interface. In this connection, the coordinates determined for each seat are integers and may be determined in the form of (x-axis value, y-axis value). In addition, pixel information may be matched in advance and pre-stored for each seat. Herein, the pixel information may refer to information on pixels corresponding to the actual seat locations within a performance hall in a production scene. In other words, one coordinate value and one piece of pixel information may be matched and pre-stored for each pixel.

For example, the drawing interface may provide the canvas 1100 configured with values of up to 2,000 along the x-axis (horizontal axis) and up to 1,000 along the y-axis (vertical axis).

In addition, as shown in the illustrated example, the coordinates such as 1500, 550 may be determined for a first seat Z1, the coordinates such as 1500, 549 for a second seat Z2, and the coordinates such as 1500, 548 for a third seat Z3 based on the pixelated location of each seat.

In this way, in an embodiment, the application 111 may determine coordinates for all seats included in the uploaded seating chart MAP.

In addition, in another embodiment, the application 111 may dynamically calculate all seats included in the uploaded seating chart MAP based on the actual dimensions of a performance hall, and a zooming in/out ratio. In this embodiment, the z-axis, which represents height, is reflected in addition to the x- and γ-axes during a pixelation process, allowing the 3D location of each seat to be considered. In this connection, an approximation algorithm that extracts the center point of the seat and minimizes overlap with surrounding pixels may be utilized.

In another embodiment, the application 111 may update the coordinates of predetermined seats included in the seating chart to reflect real-time situations at a performance hall (for example, construction or remodeling). To this end, in yet another embodiment, the application 111 may map at least one of latitude, longitude, tag ID, and/or offset to each seat. Accordingly, even when a predetermined seat is moved, the seating chart may be updated in real time to reflect the moved location.

In addition, in an embodiment, the application 111 may acquire a production sketch performed on pixels whose coordinates have been determined (S705).

Herein, a production sketch SKC according to an embodiment may refer to a drawing of the scene a producer intends to produce using the light-emitting devices 300 to be disposed in a performance hall. The production sketch SKC may be implemented by including drawings, figures, effects, and/or text. However, for convenience of description, the following description assumes that the production sketch SKC is text.

To this end, in an embodiment, the application 111 may receive a drag event input based on a drawing interface. In this connection, in an embodiment, the application 111 may measure at least one of the coordinates, drag direction, length, and/or speed of the received drag event, and immediately convert the measured value into the production sketch.

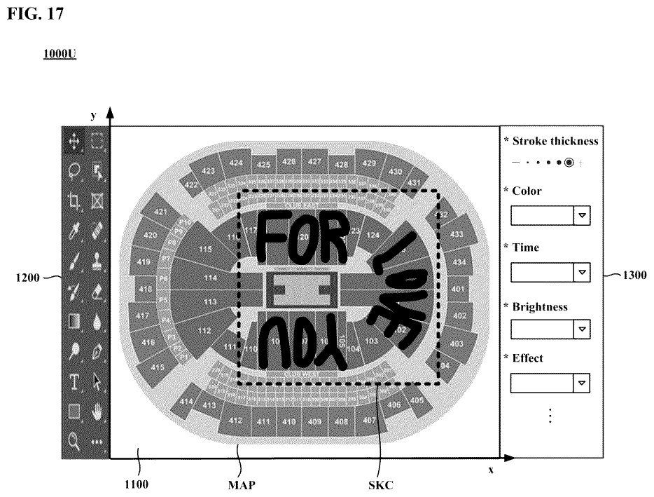

FIG. 17 is an example of a drawing sketch input to a drawing interface according to an embodiment of the present disclosure.

Referring to FIG. 17, in an embodiment, the application 111 may provide a drawing interface 1000U including the canvas 1100, a tool panel 1200, and/or a work panel 1300.

The canvas 1100 may refer to a task window for performing predetermined drawing work.

In an embodiment, the application 111 may acquire the production sketch SKC based on a producer input sensed on the canvas 1100 overlapping the seating chart MAP.

The tool panel 1200 may provide tools used when working on the production sketch SKC.

In an embodiment, the application 111 may provide tools used when working on the production sketch SKC, such as selecting, moving, zooming in/out, cropping, and inserting graphics of the production sketch SKC, based on the tool panel 1200.

The task panel 1300 may display information on the graphics being worked on in the production sketch SKC.

In an embodiment, the application 111 may adjust detailed attributes of the production sketch SKC, such as the production shape (for example, stroke thickness adjustment), production color, production time, production brightness, production effect, and production dynamic effect of the production stretch SKC, based on the work panel 1300, and display information being worked on.

In addition, in an embodiment, the application 111 may also store the production sketch SKC as an image, video, and/or frame.

In other words, in an embodiment, the application 111 may acquire the production sketch SKC input into the drawing interface 1000U including the canvas 1100, the tool panel 1200, and/or the work panel 1300.

In addition, in an embodiment, the application 111 may perform preprocessing on the acquired production sketch SKC (S707).

The production sketch SKC is a predetermined drawing input by a producer to a drawing pad. Accordingly, the points and lines are not consistent, and thus may not be input to precisely match the pixels of the seating chart MAP.

Accordingly, in an embodiment, in order to detect seats corresponding to the acquired production sketch SKC, the application 111 may perform preprocessing that classifies the relevant pixels into a production target pixel and/or a production non-target pixel based on a proportion of the production sketch SKC occupied by each pixel.

For example, the preprocessing may be performed based on an area calculation algorithm and/or collision box technology that calculates how much a vector-based drawing (stroke) covers a pixel (seat).

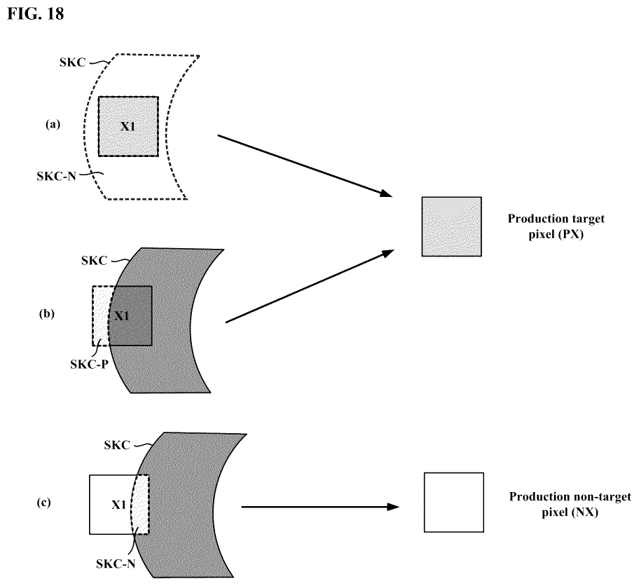

FIG. 18 is an example of a diagram illustrating preprocessing of a production sketch according to an embodiment of the present disclosure. Specifically, (a) illustrates a case where the occupancy ratio of the production sketch SKC to the first pixel is 100% or greater. (b) illustrates a case where the occupancy ratio of the production sketch SKC to the first pixel is greater than or equal to a preset reference. (c) illustrates a case where the occupancy ratio of the production sketch SKC to the first pixel is less than a preset reference.

In a first embodiment, when the occupancy ratio of the production sketch SKC to a first pixel X1 is 100% or greater, the application 111 may determine the first pixel X1 as a production target pixel PX.

In this connection, the application 111 may adjust the production sketch SKC to match an outline of the first pixel X1 by deleting an excess sketch SKC-N that exceeds the outline of the first pixel X1.

In a second embodiment, when the occupancy ratio of the production sketch SKC to the first pixel X1 is greater than or equal to a preset reference (for example, 60% or more), the application 111 may determine the first pixel X1 as the production target pixel PX.

In this connection, the application 111 may adjust the production sketch SKC to match the outline of the first pixel X1 by adding a shortfall sketch SKC-P that falls short of the outline of the first pixel X1.

In a third embodiment, when the occupancy ratio of the production sketch SKC to the first pixel X1 is less than a preset reference (for example, less than 60%), the application 111 may determine the first pixel X1 as a production non-target pixel NX.

In this connection, the application 111 may adjust such that the production sketch SKC does not exist in the outline of the first pixel X1 by deleting the production sketch SKC input to the first pixel X1.

In other words, in an embodiment, the application 111 may perform preprocessing to add and/or delete a portion of the relevant production sketch SKC to fit to the outline of the relevant pixel, depending on the occupancy ratio of the acquired production sketch SKC to each pixel.

In addition, in an embodiment, the application 111 may extract pixel information corresponding to the preprocessed production sketch SKC (S709).

In detail, in an embodiment, the application 111 may extract only filtered pixel information by removing overlap of the production target pixel PX from the preprocessed production sketch SKC.

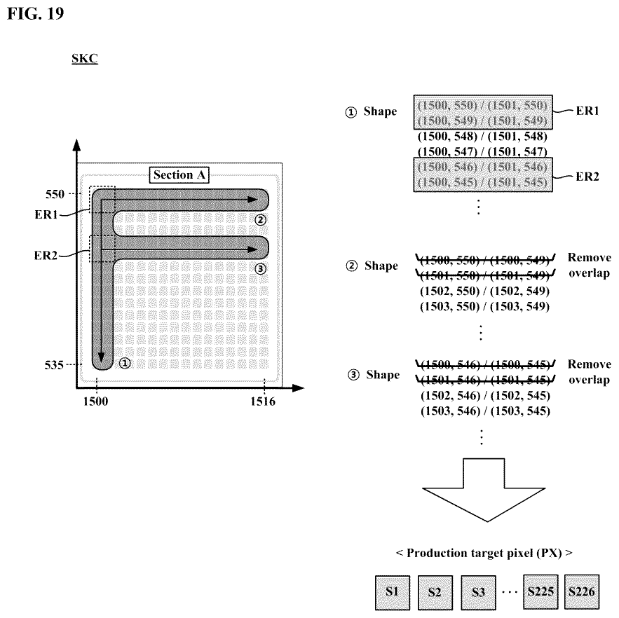

FIG. 19 is an example of extracting pixel information corresponding to a production sketch according to an embodiment of the present disclosure.

FIG. 19 illustrates an example of an “F”-shaped production sketch SKC performed for Section “A,” where the x-axis has values ranging from 1500 to 1516 and the y-axis has values ranging from 535 to 550. In this connection, pixels corresponding to the “F” shape may be the production target pixels PX, and pixels not corresponding to the “F” shape may be the production non-target pixels NX.

Referring to FIG. 19, in an embodiment, the application 111 may extract the coordinates of production target pixels PX for each of the first to third shapes configuring the preprocessed production sketch SKC. The first to third shapes may refer to figures formed by drawing strokes in the directions indicated by symbols \textcircled{1} to \textcircled{3}.

In this connection, when the first to third shapes include at least two production target pixels (PX) in the same row and/or column (in other words, when the shape is thicker than one pixel), the application 111 may preferentially record the coordinates of production target pixels PX in the same row and/or column.

In addition, in an embodiment, the application 111 may remove the coordinates of overlapping production target pixels PX in the first to third shapes configuring the preprocessed production sketch SKC. Specifically, the application 111 may store the coordinates of the initially input production target pixels PX and retain only the relevant coordinates. Thereafter, when the coordinates of the production target pixel PX already present in a shape are detected, the detected coordinates may be removed.

For example, the coordinates of the production target pixels PX corresponding to an overlapping area ER1 between the first and second shapes and an overlapping area ER2 between the first and third shapes may be removed. The removed coordinates may be recorded and stored only in the first shape.

In addition, in an embodiment, the application 111 may extract pixel information of the filtered production target pixels PX by removing overlapping coordinates.

To this end, in an embodiment, the application 111 may match in advance and pre-store pixel information with the production target pixels PX.

In the same manner, in an embodiment, the application 111 may extract the pixel information corresponding to all production target pixels PX corresponding to the production sketch SKC.

In addition, in an embodiment, the application 111 may generate light emission pattern information based on the production sketch SKC (S711).

In detail, in an embodiment, when the production sketch SKC is acquired, the application 111 may generate preset detailed attributes input based on the work panel 1300 as light emission pattern information.

To this end, in an embodiment, the application 111 may extract detailed attributes, including preset production color, production brightness, production time, and production effect, from the production sketch SKC.

In addition, in an embodiment, the application 111 may map each preset detailed attribute in the production sketch SKC to the light emission pattern component of the light emission pattern information.

In this connection, the light emission pattern component of the light emission pattern information may include light emission color, light emission brightness, light emission time, and/or light emission effect. Accordingly, the detailed attributes of the production sketch SKC may be mapped 1:1 with corresponding information in the light emission pattern component of the light emission pattern information.

Specifically, in an embodiment, the application 111 may insert a first detailed attribute preset in the production sketch SKC into a first component of the light emission pattern information, or convert the same into a first component value and insert the same.

For example, when the first detailed attribute is a production color (for example, red), the code/channel value corresponding to “red” or the production color “red” may be inserted into the first light emission pattern component that defines the light emission color.

In the same manner, by mapping the detailed attributes of the corresponding production sketch SKC and the light emission pattern component of the light emission pattern information, in an embodiment, the application 111 may generate the light emission pattern information.

The production sketch SKC may be stored as a global control, allowing input production sketches to appear all at once, and/or as a sequential control, allowing input production sketches to appear in the input order (drag order). Herein, the input order may refer, for example, to the order in which shapes are input.

In the case of global control, in an embodiment, the application 111 may set the extracted pixel information to appear all at once without linking the time code information.

In the case of sequential control, in an embodiment, the application 111 may sort the extracted pixel information in ascending and/or descending order based on the x-axis and/or y-axis of the coordinates. In addition, the time code information of the sorted pixel information may be set to be continuous at preset intervals. Accordingly, the sequential control may be performed by controlling the predetermined transmitter 200 to emit a projection signal including the pixel information and the time code information. For example, the time code information of the first to tenth pixel information may be set to 0.01 to 0.1 seconds and controlled to emit light sequentially, thereby performing a dynamic production, such as drawing a shape.

Furthermore, for this sequential control, in an embodiment, the application 111 may generate a frame including the order in which the production sketch SKC moves. The predetermined transmitter 200 may be controlled to emit a projection signal using the generated frame.

In addition, the sequential control may be performed by an algorithm that determines the movement angle, movement distance, and/or dynamic path of the transmitter 200 based on the coordinates, drag direction, length, and/or speed of the drag event of the production sketch input to the drawing interface.

In addition, when the drag range utilizes a plurality of zones, the drag path may be divided into projection areas of the transmitter and assigned to each transmitter.

In detail, in an embodiment, the application 111 may sense a drag input of the production sketch based on the drawing interface. In addition, the application may calculate the drag path (for example, direction, speed, and/or length) of the sensed drag input. In addition, dynamic path commands for the plurality of transmitters 200 may be generated based on the calculated drag path. In addition, the plurality of transmitters 200 may be operated at once or sequentially based on the generated dynamic path commands.

Herein, when the drag input speed exceeds a specific threshold (for example, an angle of 30 degrees) set based on the mechanical limitations of the transmitter, the application 111 may compensate for the drag input speed in an embodiment.

For example, the application 111 may clamp the drag input speed to a maximum or adjust the drag input speed to slow the actual movement speed of the transmitters 200 compared to the actual drag input speed using an interpolation technique.

By converting this drag input into real-time transmitter control, the application 111 supports a producer to immediately perform an intuitive and dynamic production and perform a stable performance production even when mistakes, such as performing extremely fast drag inputs, are made.

In addition, in an embodiment, the application 111 may control at least one of the central signal or the projection signal so that the light-emitting devices matching the extracted pixel information emit light according to the light emission pattern information (S713).

In detail, in an embodiment, the application 111 may control at least one of the central signal or the projection signal to convert the production sketch SKC generated in the drawing interface into light emission pattern information in real time and cause the light-emitting devices to immediately emit light according to the light emission pattern information.

To this end, in an embodiment, the application 111 may store pixel information and/or light emission pattern information based on the production sketch SKC generated in the drawing interface. In addition, the stored information may be transferred to the central control terminal 100 and/or an external terminal (for example, a separate artist/producer terminal, the transmitter 200, and/or the light-emitting device 300).

Hereinafter, the determination of whether the transmitter 200 and/or the light-emitting device 300 is to be directly controlled may be made based on whether the light-emitting device 300 pre-stores pixel information.

Herein, an embodiment may be classified into 1) a case where the light-emitting device 300 pre-stores pixel information on regarding the seat where the light-emitting device 300 is currently located, and 2) a case where the light-emitting device 300 does not pre-store pixel information.

In the first embodiment, 1) where the light-emitting device 300 pre-stores pixel information, the application 111 may update the existing central signal by adding the pixel information and light emission pattern information to the existing central signal.

In addition, in the first embodiment, the application 111 may transmit the updated central signal to at least one light-emitting device 300.

In this connection, among the light-emitting devices 300 receiving the updated central signal, only the light-emitting devices 300 that pre-store the pixel information included in the updated central signal may be controlled to emit light according to the light emission pattern information included in the updated central signal.

In the second embodiment, 2) where the light-emitting device 300 does not pre-store pixel information, the application 111 may update the light emission pattern information of the existing central signal with the light emission pattern information generated according to the production sketch SKC.

In addition, in the second embodiment, the application 111 may transmit the updated central signal to all light-emitting devices 300. Herein, all light-emitting devices 300 will not emit light according to the central signal until receiving at least one projection signal.

In this connection, in the second embodiment, the application 111 may extract at least one transmitter 200 that transmits the projection signal to the pixel information.

In addition, in the second embodiment, the application 111 may determine the frame of the extracted transmitter 200 as the shape of the production sketch SKC.

In addition, in the second embodiment, the application 111 may control the extracted transmitters 200 to transmit a projection signal including the light emission pattern information according to the determined frame.

Accordingly, among the light-emitting devices 300 receiving the updated central signal, only the light-emitting devices 300 that have received the projection signal may be controlled to emit light according to the light emission pattern information included in the updated central signal.

In other words, in the first and second embodiments, the application 111 may control the configuration of at least one of the transmitter 200 and/or the light-emitting device 300 depending on whether the light-emitting device 300 has pre-stored pixel information.

Accordingly, the application 111 according to an embodiment of the present disclosure may realize impromptu productions by artists and/or producers by converting the production sketch input to the drawing interface into pixel information and light emission pattern information in real time and controlling the light-emitting device 300 to emit light.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with one or more software modules to perform the operations of the present disclosure, and vice versa.

Specific executions described in the present disclosure are exemplary embodiments and the scope of various embodiments of the present disclosure is not limited even by any method. For brevity of the specification, descriptions of conventional electronic configurations, control systems, software, and other functional aspects of the systems may be omitted. Further, connection or connection members of lines among components exemplarily represent functional connections and/or physical or circuitry connections and may be represented as various functional connections, physical connections, or circuitry connections which are replaceable or added in an actual device. Further, unless otherwise specified, such as “essential” or “important,” the connections may not be components particularly required for application of various embodiments of the present disclosure.

Further, while the present disclosure has been described with reference to preferred embodiments in the detailed description above, it will be understood by those skilled in the art that various changes and modifications may be made without departing from the spirit and scope of the present disclosure as defined by the following claims. Accordingly, the technical scope of various embodiments of the present disclosure should not be limited to the contents described in the detailed description of the present disclosure but should be defined by the claims.

What is claimed is:

1. A method for producing a field performance for a plurality of light-emitting devices by at least one processor of a central control terminal, the method comprising:
acquiring a first control signal comprising at least one data set in which light emission pattern information is specified for each piece of transmitter identification information;
generating at least one piece of light emission state information by combining light emission pattern components included in the light emission pattern information;
transmitting the first control signal comprising the generated light emission state information to the plurality of light-emitting devices using a first communication method; and
controlling the plurality of light-emitting devices, which receive a second control signal transmitted from at least one transmitter based on a second communication method, to emit light according to the transmitted light emission state information.

2. The method of claim 1, wherein the acquisition of the first control signal pertains to acquiring the first control signal comprising the at least one data set in which the transmitter identification information comprising a transmitter number that specifies a first transmitter among transmitter numbers pre-stored for each transmitter and the light emission pattern information that determines a light emission format of the light-emitting device located within a signal range of the first transmitter are one-to-one matched.

3. The method of claim 1, wherein the generation of the light emission state information comprises:
setting at least two data sets as integrated data according to a combination corresponding to the number of cases that is able to be calculated with the transmitter identification information;
extracting, for each data set, a light emission pattern component value of the same category among the light emission pattern information included in the at least two data sets of the set integrated data;
calculating a median value of the extracted light emission pattern component value; and
inserting the extracted median value into a light emission pattern component of the same category to generate the light emission state information.

4. The method of claim 1, wherein the controlling of the plurality of light-emitting devices to emit light according to the transmitted light emission state information comprises: controlling to preferentially emit light by transitioning to the light emission state information based on a transmitter number included in the received second control signal when the light-emitting device, which used to emit light according to the first control signal of the first communication method, receives the second control signal of the second communication method.

5. The method of claim 1, wherein the second communication method of the second control signal transmitted by the transmitter is a short-range communication method having a smaller signal range than the first communication method of the first control signal transmitted by the central control terminal, and is a directional electromagnetic signal.

6. The method of claim 1, further comprising: performing a dynamic production based on a plurality of communication methods, wherein the performing of the dynamic production comprises:
generating production data based on a performance production interface;
extracting a base source based on the generated production data;
determining first dynamic production information to be performed by a first transmitter that emits a projection signal to a first zone based on the extracted base source;
generating second dynamic production information to be performed by a second transmitter that emits a projection signal to a second zone adjacent to the first zone; and
controlling at least one transmitter existing in a performance hall according to a dynamic path comprising the first dynamic production information and the second dynamic production information.

7. The method of claim 6, wherein the extraction of the base source comprises:
extracting at least one commonly used light emission pattern component among a plurality of production styles included in the production data; and
determining at least one setting value included in the extracted light emission pattern component as the base source.

8. The method of claim 6, wherein the determination of the first dynamic production information comprises:
determining at least one of a basic setting value, a minimum setting value, or a maximum setting value for a first dynamic production sequence of the first transmitter;
determining at least one of a basic setting value, a minimum setting value, or a maximum setting value for a second dynamic production sequence of the first transmitter;
mapping at least one setting value configuring the determined second dynamic production sequence to at least one setting value configuring the determined first dynamic production sequence; and
generating the first dynamic production information for controlling the first transmitter according to the setting value mapped between the dynamic production sequences for a predetermined period of time.

9. The method of claim 8, wherein the generation of the second dynamic production information comprises:
detecting an end setting value of the first dynamic production sequence mapped to an end point in time of the first dynamic production information; and
determining the detected setting value as a start setting value of the first dynamic production sequence mapped to a start point in time of the second dynamic production information.

10. The method of claim 6, further comprising:
transmitting a central signal for driving at least one piece of production data pre-stored in a plurality of light-emitting devices;
controlling the plurality of light-emitting devices to emit light by at least one of the central signal or the projection signal; and
classifying and controlling a first light-emitting device located in a first projecting shape transmitted by a first projector, a second light-emitting device located in a second projecting shape transmitted by an n-th projector other than the first projector, and a third light-emitting device located in a third projecting shape other than the first projecting shape and the second projecting shape.

11. The method of claim 1, further comprising: producing a real-time performance based on a drawing interface, wherein the producing of the real-time performance comprises:
uploading a seating chart with at least one pixelated seat to the drawing interface;
identifying pixels corresponding to a production sketch input to the drawing interface overlapping the uploaded seating chart;
generating light emission pattern information according to pixel information of the identified pixels; and
controlling at least one of the central control terminal or a transmitter in real time so that light-emitting devices matching the extracted pixel information emit light with the generated light emission pattern information.

12. The method of claim 11, wherein the uploading of the seating chart comprises:
pixelating at least one seat included in a first seating chart so that one seat one-to-one corresponds to one pixel;
determining coordinates for all the pixelated seats based on coordinate axes of a canvas included in the drawing interface; and
matching the pixel information to all the pixelated seats.

13. The method of claim 11, wherein the identification of the pixels corresponding to the production sketch comprises:
performing preprocessing to add and delete the production sketch included in a first pixel according to a proportion of the production sketch occupied by the first pixel; and
determining the preprocessed first pixel as at least one of a production target pixel or a production non-target pixel.

14. The method of claim 11, wherein the identification of the pixels corresponding to the production sketch comprises:
extracting coordinates of the production target pixel for each of at least one shape configuring the production sketch;
storing the coordinates of a first shape input initially;
removing coordinates that overlap with the coordinates extracted from the first shape among the coordinates extracted from the at least one shape input after the first shape; and
extracting pixel information of production target pixels filtered by removing the overlapping coordinates.

15. The method of claim 11, wherein the controlling of the central control terminal in real time to emit light with the generated light emission pattern information comprises:
updating a first central signal by adding first pixel information and first light emission pattern information to the first central signal;
transmitting the updated first central signal; and
controlling the central control terminal so that only light-emitting devices that have pre-stored the first pixel information included in the updated first central signal emit light according to the first light emission pattern information.

16. The method of claim 11, wherein the controlling of the transmitter in real time to emit light with the generated light emission pattern information comprises:
extracting at least one transmitter that transmits a projection signal to the first pixel information;
determining a frame of the extracted transmitter as a shape of the production sketch; and
controlling the transmitter so that the at least one transmitter transmits a projection signal comprising first light emission pattern information according to the determined frame.

17. The method of claim 16, wherein the controlling of the transmitter in real time further comprises:
sensing a drag event occurring in the production sketch;
calculating a drag path of the sensed drag event;
generating a dynamic path command for a plurality of transmitters according to the calculated drag path; and
controlling a movement speed of the at least one transmitter according to the generated dynamic path command.

18. A system for producing a field performance for a plurality of light-emitting devices, the system being interlocked with the plurality of light-emitting devices, and comprising a central control terminal comprising at least one memory and at least one processor,
wherein at least one application stored in the memory and executed by the processor operates in accordance with instructions for:
acquiring a first control signal comprising at least one data set in which light emission pattern information is specified for each piece of transmitter identification information;
generating at least one piece of light emission state information by combining light emission pattern components included in the light emission pattern information;
transmitting the first control signal comprising the generated light emission state information to the plurality of light-emitting devices using a first communication method; and
controlling the plurality of light-emitting devices, which receive a second control signal transmitted from at least one transmitter based on a second communication method, to emit light according to the transmitted light emission state information.

19. The system of claim 18,
wherein the at least one application operates in accordance with instructions for performing a dynamic production based on a plurality of communication methods by:
generating production data based on a performance production interface;
extracting a base source based on the generated production data;
determining first dynamic production information to be performed by a first transmitter that emits a projection signal to a first zone based on the extracted base source;
generating second dynamic production information to be performed by a second transmitter that emits a projection signal to a second zone adjacent to the first zone; and
controlling at least one transmitter existing in a performance hall according to a dynamic path comprising the first dynamic production information and the second dynamic production information.

20. The system of claim 18,
wherein the at least one application operates in accordance with instructions for producing a real-time performance based on a drawing interface by:
uploading a seating chart with at least one pixelated seat to the drawing interface;
acquiring a production sketch input to the drawing interface overlapping the uploaded seating chart;
preprocessing the production sketch based on coordinates of the acquired production sketch;
extracting pixel information corresponding to the preprocessed production sketch;
generating light emission pattern information based on the input production sketch; and
controlling the light-emitting devices matching the extracted pixel information to emit light with the generated light emission pattern information.
